(19) United States
(12) Patent Application Publication
(10) Pub. No.: US 2015/0310507 A1
(43) Pub. Date: Oct. 29, 2015

(54) USER ENGAGEMENT EVALUATION COMPUTER SYSTEM AND METHOD

(71) Applicant: Sticky Projects, LLC DBA RaiseMore, Oklahoma City, OK (US)

(72) Inventors: Luke Woodward, Edmond, OK (US); Devan Twyman, Oklahoma City, OK (US); Josh Bavari, Edmond, OK (US); Rob Sullivan, Edmond, OK (US); Derek Grape, Oklahoma City, OK (US)

(21) Appl. No.: 14/639,906

(22) Filed: Mar. 5, 2015

Related U.S. Application Data
(60) Provisional application No. 61/948,352, filed on Mar. 5, 2014.

(51) Int. Cl. G06Q 30/02; H04L 12/58; H04L 29/06; G06N 5/04

(52) U.S. Cl. CPC G06Q 30/0279; G06N 5/046; H04L 51/04; H04L 65/403

(57) ABSTRACT

A set of instructions is described that causes a processor to gather data streams describing a fund raising activity of one or more participant. The data streams are indicative of aspects of the fund raising activity from a group of activities including donations originated by the one or more participant, engagement of the one or more participant, and awareness of the one or more participant. The data streams are analyzed with a rule set so as to generate a metric-based hierarchy of participants based on a composite of the participant's relative contributions to the aspects of the fund raising activity. The metric-based hierarchy is stored, and data signals indicative of at least a portion of the metric—based hierarchy are transmitted to at least one computing device in a format configured to be rendered upon a display screen by the computing device using at least one predefined algorithm.

### INCORPORATION BY REFERENCE

The present patent application hereby claims priority to and incorporates by reference the entire provisional patent application identified by U.S. Ser. No. 61/948,352, filed on Mar. 5, 2014.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The inventive concepts disclosed herein generally relate to computer systems and methods for measuring user engagement, and more particularly, but not by way of limitation, to host systems, smartphone applications, and methods for measuring and analyzing user engagement in events, campaigns, and other activities.

### BRIEF DESCRIPTION OF THE SEVERAL VIEWS OF THE DRAWINGS

Like reference numerals in the figures represent and refer to the same or similar element or function. Implementations of the inventive concepts disclosed herein may be better understood when consideration is given to the following detailed description thereof. Such description makes reference to the annexed pictorial illustrations, schematics, graphs, drawings, and appendices. In the drawings:

FIG. 1 is a diagram of an embodiment of a user engagement evaluation computer system according to the inventive concepts disclosed herein.

FIG. 2 is a block diagram of an embodiment of a memory of a user engagement evaluation computer system according to the inventive concepts disclosed herein.

FIG. 3 is a block diagram of an exemplary embodiment of user engagement evaluation logic according to the inventive concepts disclosed herein.

FIG. 4 is a block diagram of an exemplary embodiment of a method of tracking donations according to the inventive concepts disclosed herein.

FIG. 5A-5B are block diagrams of an exemplary embodiment of a social polling logic according to the inventive concepts disclosed herein.

FIG. 6 is a block diagram of an exemplary embodiment of social posts and media scoring logic according to the inventive concepts disclosed herein.

FIG. 7A-7B are block diagrams of an exemplary embodiment of user behavior and communication preferences logic according to the inventive concepts disclosed herein.

FIGS. 8-9A-9F show an embodiment of event application creation automation logic according to the inventive concepts disclosed herein.

FIG. 10 is a block diagram of an embodiment of user login logic flow of an event application according to the inventive concepts disclosed herein.

FIG. 11 is a block diagram of an embodiment of event participation functionality of an event application according to the inventive concepts disclosed herein.

FIGS. 12-13 show an embodiment of a social posting functionality of an event application according to the inventive concepts disclosed herein.

FIG. 14 is a block diagram of an embodiment of a peer-to-peer fundraising logic of an event application according to the inventive concepts disclosed herein.

FIG. 15 shows a block diagram of an embodiment of event creation functionality of an event application according to the inventive concepts disclosed herein.

FIG. 16 is a block diagram of an embodiment of team functionality and communication according to the inventive concepts disclosed herein.

FIG. 17 is a block diagram of an embodiment of virtual handoff logic provided to users by an event application according to the inventive concepts disclosed herein.

FIG. 18A-18B is a block diagram of an embodiment of event training logic by an event management application according to the inventive concepts disclosed herein.

FIGS. 19-31 show embodiments of event map replay and timeline functionality of an event application according to the inventive concepts disclosed herein.

FIGS. 32-35 show an event application executed by a computing device to manage a bicycle riding event according to an embodiment of the inventive concepts disclosed herein.

FIGS. 36-48 shown an event application for managing an artistic event according to embodiments of the inventive concepts disclosed herein.

FIGS. 49, 50A, 50B, 51-52 show an exemplary embodiment of do-it-yourself fundraising event functionality provided by an event application according to the inventive concepts disclosed herein.

FIGS. 53A-53C, 54, 55A-55C, 56A-56C & 57A-57C show examples of event application functionality according to some embodiments of the inventive concepts disclosed herein.

FIGS. 58-63 show block diagrams of exemplary embodiments of user engagement evaluation logic according to the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

The inventive concepts disclosed herein are generally directed to user engagement evaluation computer systems, smartphone applications, and methods, and more particularly, but not by way of limitation, to user engagement evaluation computer systems, smartphone applications, and methods for measuring and analyzing participant and supporter engagement in charity events and activities.

As used herein, the terms “network-based,” “cloud-based” and any variations thereof, are intended to cover the provision of configurable computational resources on demand via interfacing with a computer network, with software and/or data at least partially located on the computer network, by pooling the processing power of two or more networked processors, for example.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

As used herein the notation “a-n” appended to a reference numeral is intended as merely convenient shorthand to reference one, or more than one, and up to infinity, of the element or feature identified by the respective reference numeral (e.g., 134a-n). Similarly, a letter following a reference numeral is intended to reference an embodiment of the feature or element that may be similar, but not necessarily identical, to a previously described element or feature bearing the same reference numeral (e.g., 148, 148a, 148b, etc.). Such shorthand notations are used for purposes of clarity and convenience only, and should not be construed to limit the instant inventive concepts in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment, and the inventive concept disclosed herein are intended to encompass any and all combinations, subcombinations, and permutations including one or more of the features described or inherently present herein and/or obvious variations thereof.

User engagement evaluation systems and methods according to the inventive concepts disclosed herein are configured to allow users and organizations to aggregate and analyze various data streams and to view user engagement in intelligent and visually-compelling manner. Embodiments of the inventive concepts disclosed herein allow users to determine and evaluate the connection between user engagement and a donation made to an organization. A variety of tools are provided to users by user engagement evaluation systems to support engagement and increase donations while providing multiple donation analytics solutions in some embodiments of the inventive concepts disclosed herein.

Further, user engagement evaluation systems, methods, and event applications according to the inventive concepts disclosed herein may be integrated with, or implemented as an add-on to any desired third party donation or service, to enable organizations to hold events and to measure user engagement, for example.

For example, in some embodiments, event applications according to the inventive concepts disclosed herein may allow users to engage with one another as users participate in events or support event participants, and captures data which are transmitted to a central database and/or host system for further processing and/or storage. The data may include behavioral data of event participants and supporters, social media sharing data, donation data, geospatial data, photos, videos, images, text-based updates, social network posts and interactions between users and organizations, or combinations thereof. For example, social network updates such as status updates, pictures, videos, or other media may be aggregated (e.g., in real-time), and a global activity feed of aggregated data customized by organization, event, team, participant, or supporter may be provided to one or more users of the user engagement evaluation system and/or an event application according to the inventive concepts disclosed herein.

Further, in some embodiments, user teams may have a team page provided by an event application, which team page may include information indicative of one or more of: a list of team members, team goal, team or individual goal progress, interactive team-member location and/or activity map, activity recording information (e.g., activity type, start, stop, completed, times), interfaces allowing users to donate to and/or encourage team members or other event participants, event route, event start time, or any other desired information. Team members may receive notifications (e.g., push notifications) when team goals or milestones are achieved in some embodiments.

Users of event applications according to the inventive concepts disclosed herein may interact with one another before, during, or after and event, such as by encouraging or donating to one another, messaging one another, sending photos, videos, images, or other updates to one another, sending social network updates to one another or to the public, sending donation links to one another, or combinations thereof. Event participants and organization representatives may be provided with dashboards and/or interactive reports indicative of user engagement and donation information for events, event participants, and supporters, in some embodiments.

In some embodiments, users or team members may virtually handoff an activity to team members or other users, allowing events to be carried out across national or state borders, various activities, and allowing multi-day, multi-activity, or multi-location events to be coordinated and carried out through event applications and user engagement evaluation systems and methods according to the inventive concepts disclosed herein.

Organization representatives may be provided with a dashboard including actionable data indicative of user engagement and event information, in some embodiments. For example, representatives may be presented with a graphical indicator of which user, shared item, social network channel, team, post, or other factor drove a donation to the organization. Further, representatives may be provided with an interactive multi-layer map indicative of current or past event actions, shared items, timeline, times and/or locations with clusters of participant or supporter activity (e.g., sharing items or driving donations), or visual or graphical indicators of impact of individual events, participants, shared items, supporters, and/or members of the public (e.g., as relating to donations or other engagement with the organization).

In some embodiments, representatives may be provided with information indicative of preferred communication channels by each user by the user engagement evaluation system. Additionally, embodiments of user engagement evaluation systems according to the inventive concepts disclosed herein may provide organization representatives with aggregated actionable information for shared items (e.g., photos, videos, social network or other updates, and/or donation links) indicative of why a certain item was ranked at a certain rank by the system, top donors based on the item, top users sharing this or similar items, top comments about the item, or combinations thereof, for example.

In some embodiments, the interactive map functionality provided to organization representatives by user engagement evaluation systems according to the inventive concepts disclosed herein may be provided as event replay and/or timeline data, allowing users to replay a desired event and observe a timeline-based indicators of user engagement, clusters (e.g., temporal or geospatial) of user activities, supporter engagement, social media buzz, sharing actions, or activities, or any other desired activities, event, or information allowing the representative to evaluate user engagement. The representative may control the timeline view at any desired granularity, and may pause, rewind, decrease or increase timing increment or replay speed, or control the event replay in any other desired manner. In some embodiments, the event replay and/or timeline data may be provided to users in real-time or substantially real-time, as will be appreciated by persons of ordinary skill in the art having the benefit of the instant disclosure.

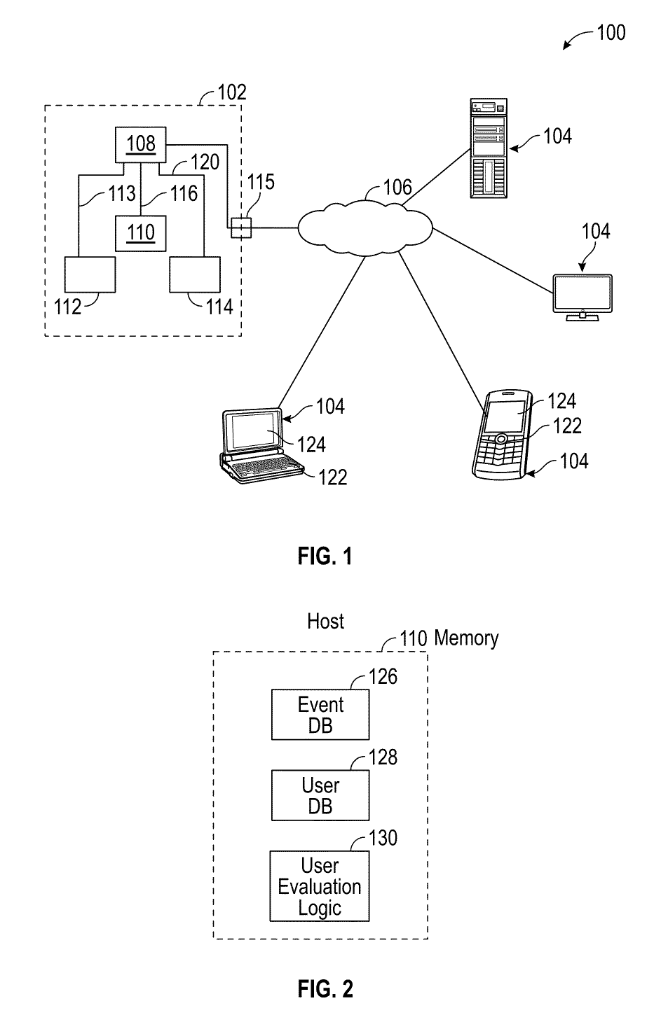

Referring now to FIG. 1, shown therein is an exemplary embodiment of a user engagement evaluation system 100 according to the inventive concepts disclosed herein. The user engagement evaluation system 100 includes one or more host system 102 capable of interfacing and/or communicating with one or more computing device 104 over a network 106.

The host system 102 includes at least one processor 108 capable of executing processor executable code, one or more non-transitory memory 110 capable of storing processor executable code and/or data, an input device 112, an output device 114, and at least one I/O port 115, all of which can be partially or completely network-based or cloud-based, and not necessarily located in a single physical location.

The processor 108 can be implemented as at least one or a single processor 108 or multiple processors 108 working together to execute the logic described herein. Exemplary embodiments of the processor 108 include a digital signal processor (DSP), a central processing unit (CPU), a field programmable gate array (FPGA), a microprocessor, a multi-core processor, and combinations thereof. The processor 108 is capable of communicating with the memory 110 via a path 116 which can be implemented as a data bus, for example. The processor 108 is capable of communicating with the input device 112 and the output device 114 via paths 120a and 120b, respectively. Paths 120a and 120b may be implemented similarly to, or differently from, path 116. The processor 108 is further capable of interfacing and/or communicating with one or more computing device 104 via the network 106, such as by exchanging electronic, digital and/or optical signals via one or more physical or virtual ports using a network protocol such as TCP/IP, for example. It is to be understood that in certain embodiments using more than one processor 108, the processor(s) 108 may be located remotely from one another, located in the same location, or comprising a unitary multi-core processor (not shown). The processor 108 is capable of reading and/or executing processor executable code and/or or creating, manipulating, altering, and storing computer data structures into the memory 110.

The memory 110 stores processor executable code and/or data and may be implemented as any desired non-transitory computer memory 110, such as random access memory (RAM), a CD-ROM, a hard drive, a solid state drive, a flash drive, a memory card, a DVD-ROM, a floppy disk, an optical drive, and combinations thereof, for example. It is to be understood that while the memory 110 is shown located in the same physical location as the host system 102, one or more memory 110 may be located remotely from the host system 102 and may communicate with the processor 108 via the network 106. Additionally, when more than one memory 110 is used, one or more memory 110a may be located in the same physical location as the host system 102, and one or more memory 110b may be located in a remote physical location from the host system 102. The physical location(s) of the memory 110 can be varied, and the memory 110 may be implemented as a “cloud memory” e.g., one or more memory 110 which is partially, or completely based on or accessed using the network 106.

The input device 112 transmits data, information, or signals to the processor 108, and can be implemented as a keyboard, a mouse, a touch-screen, a camera, a cellular phone, a tablet, a smartphone, a PDA, a microphone, a network adapter, and combinations thereof, for example. The input device 112 may be located in the same physical location as the host system 102, or may be remotely located and/or partially or completely network-based. The input device 112 communicates with the processor 108 via path 118.

The output device 114 transmits information from the processor 108 to a user, such that the information can be perceived by the user. For example, the output device 114 can be implemented as a server, a computer monitor, a cell phone, a tablet, a speaker, a website, a PDA, a fax, a printer, a projector, a laptop monitor, and combinations thereof. The output device 114 can be physically co-located with the host system 102, or can be located remotely from the host system 102, and may be partially or completely network based (e. g., a website). The output device 114 communicates with the processor 108 via the path 120. As used herein the term “user” is not limited to a human, and may comprise a human, a computer, a host system, a smart phone, a tablet, and combinations thereof, for example.

The at least one I/O port 115 may be may be implemented as any desired virtual or physical computer port such as an optical port, a wireless transceiver, an Ethernet port, a USB port, an HDMI port, and is configured to transmit one or more signals over the network 106 and/or to receive one or more signals from the network 106. Any desired number of I/O ports 115 may be implemented with the inventive concepts disclosed herein, and in some embodiments one or more I/O ports 115 may be implemented as dedicated output ports, and one or more I/O ports 115 may be implemented as dedicated input ports.

The network 106 preferably permits bi-directional communication of information and/or data between the host system 102 and the computing devices 104. The network 106 may interface with the host system 102 and the computing devices 104 in a variety of ways, such as by optical and/or electronic interfaces, and may use a plurality of network topographies and protocols, such as Ethernet, TC/IP, circuit switched paths, and combinations thereof, for example. For example, the network 106 can be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof, and may use a variety of network protocols to permit bi-directional interface and communication of data and/or information between the host system 102 and the one or more computing devices 104.

The computing device 104 can be implemented as a personal computer, a smartphone, network-capable TV set, TV set-top box, a tablet, an e-book reader, a laptop computer, a desktop computer, a network-capable handheld device, a video game console, a web server, a database, a host system, a digital video recorder, a DVD-player, a Blu-Ray player, and combinations thereof, for example. In an exemplary embodiment, the computing device 104 includes an input device 122, an output device 124, a processor (not shown) capable of interfacing with the network 106 via one or more computer ports, processor executable code stored in a non-transitory processor readable medium (not shown), and a web browser capable of accessing a website and/or communicating information and/or data over a network, such as the network 106. As will be understood by persons of ordinary skill in the art, the computing device 104 may include one or more non-transitory processor readable memories storing processor executable code and/or a smartphone application and/or storing one or more databases accessible via the network 106, for example.

The input device 122 is capable of receiving information input from a user and/or another processor, and transmitting such information to a processor of the computing device 104 and/or to the host system 102. The input device 122 may be implemented as a keyboard, a touch-screen, a mouse, a trackball, a microphone, a fingerprint reader, an infrared port, a slide-out keyboard, a flip-out keyboard, a cell phone, a PDA, a video game controller, a remote control, a fax machine, a network interface, and combinations thereof, for example.

The output device 124 outputs information in a form perceivable by a user and/or readable or executable by another processor. For example, the output device 124 can be a server, a computer monitor, a screen, a touchscreen, a speaker, a website, a TV set, a smart phone, a PDA, a cell phone, a fax machine, a printer, a laptop computer, a tablet, and combinations thereof. It is to be understood that in some exemplary embodiments, the input device 122 and the output device 124 may be implemented as a single device, such as, for example, a touch-screen or a tablet. It is to be further understood that as used herein the term user is not limited to a human being, and may comprise a computer, a server, a website, a processor, a network interface, a human, a user terminal, a virtual computer, and combinations thereof, for example.

Referring now to FIG. 2, the memory 110 may store processor executable code and/or information which may include an event database 126, a user database 128, and user evaluation logic 130. The processor executable code may be written in any suitable programming language, such as C++. The event database 126 and the user database 128 can be stored as a data structure, such as a relational database and/or one or more data table(s), for example.

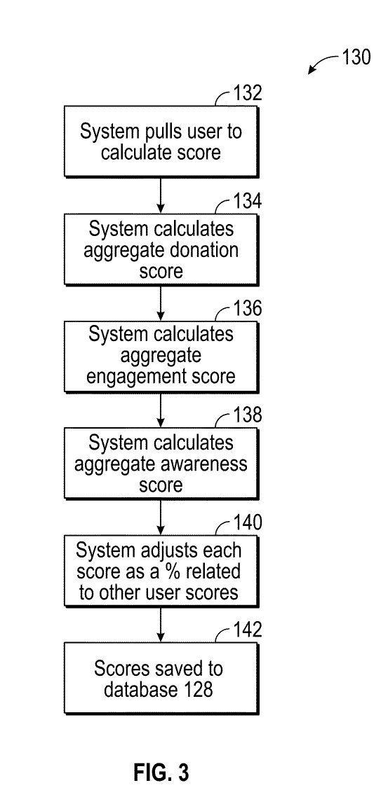

Referring now to FIG. 3, in some embodiments, the user evaluation logic 130 may be implemented as software or processor-executable instructions for causing the processor 108 to evaluate or score users such as charity event participants or supporters in one or more areas as described below. In some embodiments, the user evaluation logic 130 may cause the processor 108 of the host system 102 to evaluate, score, or rank users (e.g., charity event participants, charity event or campaign donors, or any other person or entity) in one, two, three, or more different areas, including one or more of: donations, engagement, and awareness. The user evaluation logic 130 may be applied to photos, posts, and donation links generated by users and shared via social media to evaluate, score, or rank users. In some instances where multiple evaluation factors or areas are implemented, different factors or areas may be weighed differently or equally by the user evaluation logic 130. For example, assuming three areas are used by the user evaluation logic 130, the three areas can be weighted by the logic based on used specifications and/or by default to Area 1-34%, Area 2-33%, and Area 3-33%. The user evaluation logic 130 may allow users to customize area weights in any desired manner, as certain users may value one area significantly higher than another, or may wish to minimize, maximize, or exclusively rely on one or more of the available areas.

In one exemplary embodiment depicted in FIG. 3, the host system 102 may execute the user evaluation logic 130 to pull a user to calculate a score as indicated by a block 132, and then evaluate the user based on three criteria: donations, engagement, and awareness as indicated in blocks 134, 136 and 138. For example, donations may be scored as a percent raised versus predetermined donation goals. Awareness may be calculated using the user's reach across any social networks where the user has posted content, with each type or contact and interaction being weighted differently based on potential impact. Engagement may be calculated based on the types of user interactions on different social networks along with the interactions of their supporters and followers. Each type of interaction may weighted differently based on potential impact. The user evaluation logic 130 may also take into account interactions on third party pages if third party integration is present. The user evaluation logic 130 then adjusts each score as a percentage related to the other user scores as indicated by a block 140, and also saves the scores in the user database 128 as indicated by a block 142, Once one or more area score is calculated for a user, the user's score may be compared against other users in that area and adjusted as a percent related to the other users, in some embodiments.

In one exemplary embodiment, the user evaluation logic 130 implements three areas including donations, engagement, and awareness, and the maximum user score awarded to a user by the user evaluation logic 130 may be 1000 points. It is to be understood that one or more of the three areas may be omitted, and any other areas may be added and/or substituted. Further, while the user score is described in detail as a score out of 1000 maximum numerical points in this example, any desired scoring, evaluating, or ranking system may be implemented with the user evaluation logic 130, such as a color system, bronze-silver-gold-platinum-diamond system, underperforming-average-good-great-super participant, or combinations thereof. Further, in some embodiments, no maximum user score may be assigned, or users may be assigned a default minimum score or any desired maximum score, or combinations thereof.

In one embodiment, the user evaluation logic 130, when executed by the processor 108 may cause the host system 102 to determine or calculate a user donation score, value or rank for a user as a percent of how close the user is to a preset goal. In this example, a preset donation goal is assigned or otherwise associated with each user by the user evaluation logic 130. The donation goal may be selected by the user, or may be selected by a charitable organization holding a campaign in which the user participates. In some embodiments, the user evaluation logic 130 may provide bonus points or special evaluation factors to users exceeding a preset donation goal by a predetermined amount or percentage. The donation score calculated by the user evaluation logic 130 can be conveyed to the respective charitable foundation or organization as an indicator of how effective of a fundraiser a particular user is, and/or as indicator of the effective fundraisers for that particular organization or event.

For example, if a user's goal is $1000 and the user has raised $800, the user evaluation logic 130 may cause the processor 108 to calculate the donation score of the user score using the following formula:

points=(amount raised/goal)*(max points*area pct)

This would give the user a donation score of 272 points in this example. The user evaluation logic 130 may cause the processor 108 to associate the calculated donation score with the particular user and to store the calculated donation score in the memory 110 (e.g., in the user database 128).

In some embodiments, the host system 102 and/or the user evaluation logic 130 may monitor donations received on behalf of the user or as a result of the user's participation in an event or campaign, and may save and/or update the donation information in the user database 128 and/or in the event database 126. The user evaluation logic 130 may recalculate the user's donation score based on the received donations in real-time, substantially in real time, intermittently, or at preset intervals or donation amounts, and may store the calculated or updated score in the user database 128 and/or may transmit the score over the network 106 to a remote database or to one or more computing devices 104.

In some embodiments, the user evaluation logic 130 may calculate an awareness score for the user by using a user's reach across one or more social networks. Social network factors such as contacts and occurrences may be weighted differently based on the potential impact by the user evaluation logic 130. The awareness score for a user may be conveyed to organizations as being indicative of the influence a particular user and/or a particular social media or channel has in generating or driving awareness for the organization.

For example, where the user evaluation logic 130 is integrated with one or more third party systems that has donation or fundraising pages or platforms, the user evaluation logic 130 may assign, provide, or calculate scoring to activities that occur on third-party pages or social networks, depending, for example, on the integration and the type of functionality that the third party fundraising pages or platforms offer. In some embodiments, predetermined basic scoring and/or weighing factors may be implemented with the user evaluation logic 130. In one example, the following scoring and weighing factors may be implemented:

Contacts/Connections of the user may be scored with 1 point for every 10 contacts or connections. Contacts/Connections from a sharer (e.g., another user sharing the user's content)—1 point from every 10. Email contacts—1 point for every 10. Text message contacts—1 point for every 2. Direct message contacts—1 point for every 5. Third party page likes—1 point for every 2, Third party page fans—1 point for every 2. Third party page shares—1 point for every 10 sharer contacts.

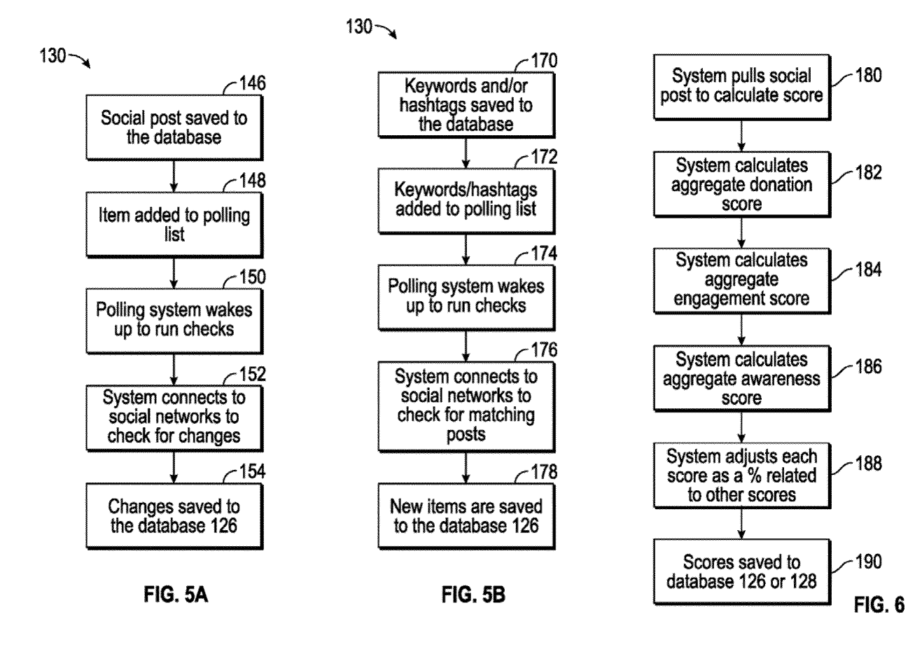

As shown in FIG. 5A-5B, the user evaluation logic 130 may cause the processor 108 of the host system 102 to poll social networks in real time or substantially real time and save the social posts in the event database 126 as indicated by blocks 146, 148, 150, 152 and 154, and the user evaluation logic 130 may recalculate or update the scores of each user each time a change is detected and may store such score in the user database 128 and/or in the event database 126.

In one example, the user evaluation logic 130 may calculate raw scores based on the above point system, and use any appropriate mathematical, statistical, or other formula to optionally group the raw scores into two or more groups. This optional grouping may allow the user evaluation logic 130 to score and/or compare each user relative to other users. For instance, assuming a user has 1000 friends on a first social network (e.g., Facebook) and 2300 followers on a second social network (e.g., Twitter), and the user sends two posts on the first social network (e.g., two wall posts or status updates) and one post on the second social network (e.g., one tweet). The user also creates a fundraising campaign and sends text messages to 140 of the user's phone contacts. Further, the user has a third party fundraising page with 50 fans, and this page was shared to the first social network by 2 people who have a total of 1250 friends.

In this example, the user evaluation logic 130 may calculate the user's raw score as follows:

raw=((1000/10)*2)+((2300/10)*1)+((140/2)*1)+((50/2)+(1250/10))=650

To illustrate the grouping of raw scores by the user evaluation logic 130, assume that there are a total of 10 users and the raw scores of the fall like this: User1-60, User2-110, User3-150, User4-155, User5-200, User6-500, User7-600, User8-650, User9-1200, and User10-1500. Below are exemplary mathematical calculations that may be carried out by the user evaluation logic 130 to group the ten users:

mean=(60+110+150+155+200+500+600+650+1200+1500)/10=512

variance=(−452̂2+−402̂2+−362̂2+−357̂2+−312̂2+−12̂2+82̂2+137̂2+687̂2+987̂2)/10=2198162

standard deviation=sqrt(variance)=468

z-score=(650-mean)/standard deviation=0.29

The user evaluation logic 130 may use each user's z-score to determine which group the user falls in. The user's awareness score may be determined by the user evaluation logic 130 individually, or based on a group of the user relative to other users. In some examples, the user evaluation logic 130 may assign users to the following groups based on the user's z-score calculated as described above:

if z-score<=−2 then floor=0, ceiling=0.16 (Group 1)

else if z-score<=−1 then floor=0.17, ceiling=0.32 (Group 2)

else if z-score<=0 then floor=0.33, ceiling=0.5 (Group 3)

else if z-score<=1 then floor=0.51, ceiling=0.66 (Group 4)

else if z-score<=2 then floor=0.67, ceiling=0.82 (Group 5)

else floor=0.83, ceiling=1 (Group 6)

In this example, the user may fall in Group 4, and the user's floor is 0.51 and the user's ceiling is 0.66. The user evaluation logic 130 may proceed to set these two variables in the awareness score calculation equation:

pct=0.51

additional pct=(0.66−0.51)*0.29=0.04

The user evaluation logic 130 may calculate awareness score for the user via the following formula:

Awareness score=(max points*area pct)*(pct+additional pct)

In the instant example, this results in an awareness score of 181 points for the user. It is to be understood that any desired number of groups may be implemented, including a single group, two groups, three groups, or more than six groups. Further, in some embodiments, the grouping may be omitted. The awareness score for the user may be stored in the user database 128 and/or may be transmitted to the user's computing device 104 via the network 106 in some embodiments.

The user evaluation logic 130 may calculate a user's engagement score based on the different actions the user performs on social networks along with the actions of the user's followers and supporters. Similar to awareness, different actions may be scored based on their potential impact. The engagement score may to enable charities or other users or organizations to determine which users are engaged with their supporters and which channels drive user and supporter engagement with an organization (e.g., a charity), event, or campaign.

Similarly to calculating the awareness score, the user evaluation logic 130 may implement third party integration to calculate an engagement score for a user. For instance, the user evaluation logic 130 may use the following action and may weigh such actions as follows:

Social post with a photo—10 points. Social post without a photo—5 points. Replies, comments, retweets, or shares—2 points. Likes, favorites—1 point. Donation link clicks—10 points. Donation from a link click—20 points. Post Shares—20 points. Third party page shares—20 points. Third party page comments—10 points

Similarly to calculating the awareness score, the user evaluation logic 130 may calculate a raw engagement score for each user and apply the formula to determine final engagement scores for a user.

Continuing with an example, assume a user posts two posts on a first social network (e.g., Facebook), one post with a photo or an image and one post without a photo or an image. The user also posts one post on a second social network (e.g., Twitter) without an image or a photo. The posts on the first social network generated 30 likes and 12 replies, and the post on the second social network generated 2 favorites, 5 replies, and 1 retweet. A third party fundraising page of the user has 10 comments and two social network shares. The shares generated 12 likes and 5 replies. The donation links the user sent out generated 50 link clicks which generated $800 from 13 donations.

The user evaluation logic 130 may calculate the user's raw score as follows:

fb=10+5+(30*1)+(12*2)+(20*2)=109

tw=5+(6*2)+(2*1)=19

fb clicks=20*10=200

tw clicks=10*10=100

text clicks=10*10=100

donations from fb clicks=8*20=160

donations from tw clicks=3*20=60

donations from text clicks=2*20=40

3rd party=(10*10)+(12*1)+(5*2)=122

=1010

Assuming there are a total of 10 users and the raw scores fall like this: User1-50, User2-65, User3-110, User4-400, User5-550, User6-600, User 7-888, User8-1010, User9-1200, and User10-1250. Below is an example of mathematical calculations that may be used by the user evaluation logic 130 to group the ten users:

mean=(50+65+110+400+550+600+888+1010+1200+1250)/10=612

variance=(−562̂2+−547̂2+−502̂2+−212̂2+−62̂2+12̂2+275̂2+397̂2+587̂2+637̂2)/10=190335

standard deviation=sqrt(variance)=436

z-score=(1010-mean)/standard deviation=0.93

Once the user's z-score has been determined, the user evaluation logic 130 may determine which group the user falls in. The user's engagement score may be defined by that group. The groups may be as follows:

if z-score<=−2 then floor=0, ceiling=0.16 (Group 1)

else if z-score<=−1 then floor=0.17, ceiling=0.32 (Group 2)

else if z-score<=0 then floor=0.33, ceiling=0.5 (Group 3)

else if z-score<=1 then floor=0.51, ceiling=0.66 (Group 4)

else if z-score<=2 then floor=0.67, ceiling=0.82 (Group 5)

else floor=0.83, ceiling=1 (Group 6)

For this example, the user falls in group 4, so the user's floor is 0.51 and the user's ceiling is 0.66. The user evaluation logic 130 may set the next two variables in the equation:

pct=0.51

additional pct=(0.66−0.51)*0.93=0.13

The user evaluation logic 130 may calculate the engagement score for the user using the following formula:

score=(max points*area pct)*(pct+additional pct)

In this example, this calculation results in an awareness score of 211 points. The awareness score may be stored in the user database 128 and/or may be transmitted to one or more computing device 104 via the network 106.

Once the user evaluation logic 130 has calculated the user's score in one or more of the desired areas, the user evaluation logic 130 may calculate or determine a total user score. In the examples given above, the user evaluation logic 130 may add the donation score (272 points), the user awareness score (181 points), and the user engagement score (211 points) to get the user's total score, which in this example is 664 points.

As will be appreciate by a person of ordinary skill in the art having the benefit of the instant disclosure, the above algorithms implemented with the user evaluation logic 130 are exemplary embodiments, and user evaluation logic 130 according to the inventive concepts disclosed herein may be implemented with any desired algorithm, formula, or calculation, to derive scores or other indicators of a user's donation activities or impact, awareness generated, and engagement of the user, or the user's supporters with an event, organization, or campaign. Further, the weighing of each section or area may not be customizable, and each section or area may be preset. Alternatively, section or area scores may be aggregated rather than calculated as a percent of a maximum score as shown in FIG. 6. In some embodiments, the donation score may be calculated as a flat or uncapped score based on the amount of money raised by the user. Finally, the areas may not be weighed and/or may be equally weighted in some embodiments. Further, in some embodiments, users may not be ranked against other users, and may simply be scored on any desired areas as described above.

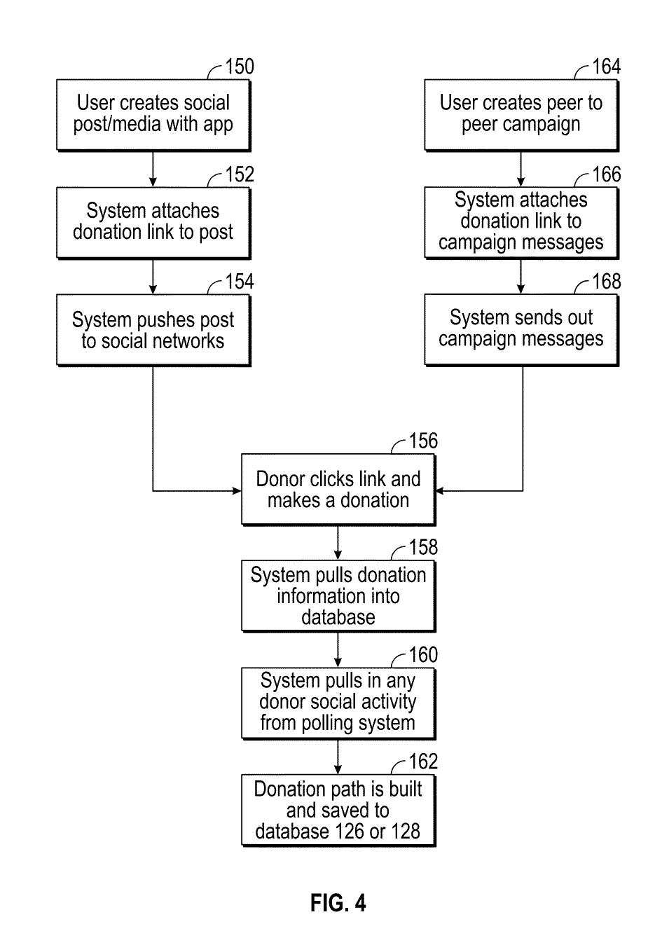

Referring now to FIG. 4, in some embodiments the host system 102 may attach tracking information to donation links, photos, videos, or other media or links that are provided to at least one of the computing device 104 and/or to a user by the host system 102, to determine where donations come from. For example, as shown in FIG. 4, the user creates a social post/media with an event application running on the user's computing device 104 as indicated by block 150. The host system 102 and/or the user's computing device 104 attaches a donation link to the post as indicated by block 152 and then the host system 102 and/or the user's computing device 104 pushes the post to one or more social networks as indicated by block 154 The tracking information may include unique identifiers which may be associated with a particular user and/or event (e.g., a charity event) and which are stored in the event database 126 and/or in the user database 128. The unique identifiers are associated with each donation link that may be generated by the host system 102, and the resulting data may be stored in the memory 110.

In some cases, where the host system 102 is integrated with a third party donation system, the host system 102 may pull in donation information from the third party donation system over the network 106 (e.g., via an API) and match the donation information up with user information and/or the unique identifiers stored in the memory 110. Further, in some cases, the host system 102 may provide callback URLs that the third party donation system may use to redirect the user to the host system 102 after a donation is made or after a link is followed. The callback URLs may include any desired tracking and donation information to enable the host system 102 to save the donation information and/or to associate the donation information with a particular user in the user database 128 and/or a particular event in the event database 126.

A donor may click on a link to make a donation as indicated by block 156, and the host system 102 may process the donation information to determine which social post, email, text, video, photo, or other post or link drove the donation as indicated by block 158. The host system 102 may pull in any donor social activity using a polling system as indicated by block 160, and then the host system 102 may generate or build a path of activity before the donation was made and may associate that path or activity with a user or a charity event as indicated by block 162. The host system 102 may evaluate at social activity from via a social polling system as described below and match up a donor to that activity and build a donation path, which donation path may be stored in the event database 126 and/or in the memory 110 and may be made available to users for reporting purposes. In some embodiments, the third party may be provided by the host system 102 with an API endpoint that the third party calls once a donation is made in the third party donation system. The third party donation system may be implemented as one or more of the computing device 104 or a third party website or web server coupled with the host system 102 via the network 106, in some embodiments. In some embodiments, the user may create a peer to peer campaign as indicated by a block 164. In this instance, the host system 102 may attach a donation link to the campaign message as indicated by a block 166, and the host system 102 may send out the campaign message(s) to one or more social networks as indicated by a block 168.

Referring again to FIG. 5A-5B, in some embodiments, the host system 102 may include a social polling logic stored in the memory 110, which when executed by the processor 108 may cause the host system 102 to monitor social networks to pull or otherwise obtain and store user activity into the event database 126 and/or the user database 128. The host system 102 may provide the user activity information to an event application executed by the computing devices 104 as described below. The user activity information may also be used by the host system 102 to calculate user scores and determining behavior. For example, when a new social item is posted by a user and saved to the user database 128 and/or event database 126 by the host system 102, the host system 102 may pull or otherwise obtain the appropriate information and add the information to a polling list which may be stored in the memory 110. In some embodiments, the host system 102 may connect (e.g., in real-time, intermittently, or periodically) to a social network and pull in updates (likes, comments, retweets, status updates, shares, pins, or other social network items or events) from each social item that the host system 102 is monitoring. In addition to monitoring individual posts, as shown in FIG. 5A-5B, the host system 102 may also monitor social networks globally for keywords and hashtags which may be associated with any particular user, charity, charity event or campaign, or activity and stored in the event database 126 and/or user database 128 as indicated by the blocks 170, 172, 174, 176 and 178. These items can also be provided by the host system 102 to one or more computing devices 104 executing an event application as described below. In some embodiments, the host system 102 may poll an organization's fan page (or similar), pull in social activity that happens there, and store the respective information in the event database 126 and/or the user database 128, or may provide the respective information to one or more computing devices 104 executing an event application as described below.

It is to be appreciated that the user evaluation logic 130 may be used to calculate or determine similar scores for social posts and photos for users. Further, the user evaluation logic 130 may determine the reach and engagement for each item using a similar point system to the one describe above. This may allow an organization to understand which photos and posts are most effective at engagement, awareness, and raising donations.

Referring now to FIG. 6, in some embodiments, the host system 102 may score social posts and media (e.g., text, pictures, and/or videos) similarly to scoring users. The host system 102 may pull (e.g., by sending one or more request signals over the network 106 and receiving one or more signals responsive to the requests) or otherwise obtain social post information as indicated by a block 180. For example, one or more of the above areas may be used for scoring social media: donations (as indicated by a block 182), engagement (as indicated by a block 184), and awareness (as indicated by a block 186) for users or events. Similar weighted point systems may be used for scoring each social item in each section, in some embodiments as indicated by a block 188 and the scores saved to either the event database 126 and/or the user database 128 as indicated by a block 190. In embodiments where aggregate scores are created for an item, the host system 102 may adjust the scores as a percent related to social items of the same type. In some embodiments, the weighing system for social items may differ from the weighing system for users described above or may be omitted. The social media scores may be stored by the host system 102 in the event database 126 and/or the user database 128 and/or may be transmitted to the computing device 104 executing an event application.

In some embodiments, the user evaluation logic 130 may further determine which method of communication may be best by ranking the methods of communication employed by users. Continuing with the example from above, the user's social aggregates are as follows:

Facebook—669

Twitter—399

Text—210

Email—0

Based on those scores, the user evaluation logic 130 may determine that this particular user would prefer to be contacted via Facebook. This feature may allow charitable organizations to reach users such as charity event participants, supporters, and donors more effectively.

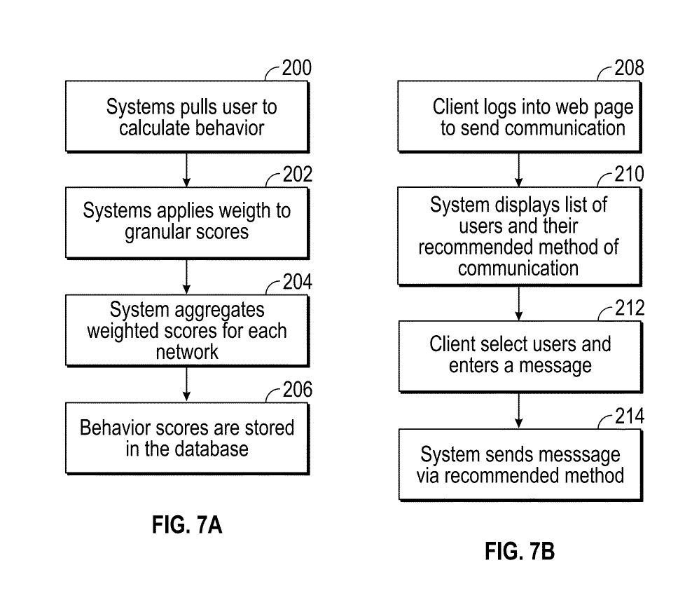

Referring now to FIG. 7A-7B, in some embodiments, the host system 102 may determine user behavior and communication preferences as follows. When the host system 102 calculates and stored user scores as described above, the host system 102 may determine which social channels a user is more likely to engage with, and the host system 102 may provide this information to a user, such as a charity organization representative. The user may use this information for improved communication with other users or supporters. For example, if a user mainly engages on a particular social network such as Twitter, then it would make sense for an organization to communicate with that user through Twitter, rather than through standard email. To rank social channels for a user, the host system 102 may take each social post and media score at any desired granularity (e.g., as described in FIG. 6) and apply a weight to the score as indicated by blocks 200 and 202. The host system 102 may aggregate the scores for each social network and rank the final scores, in some embodiments as indicated by a block 204 and behavior scores are stored in the event database 126 and/or the user database 128 as indicated by block 206. As indicated by a block 208, a user can log into a web page or dashboard maintained or provided by the host system 102 and may be presented with a list of users and a recommended method of communication with each user as indicated by a block 210. The host system 102 may allow a user (e.g., a representative of an organization) to communicate with certain users through the recommended methods via the host system 102 by permitting the user to select particular user(s) and enter a message as indicated by a block 212. The message is then sent by the host system 102 to the particular user(s) via the recommended method(s) as indicated by a block 214. In some embodiments, users may override the recommendations of the host system 102 and may communicate with other users via any desired channel or method provided by the host system 102.

In some embodiments granular social network scores may not be weighed by the host system 102, and raw scores may be aggregated without weighing. Further, in some embodiments, user behavior may be used to understand which social channels are most effective in fundraising and engagement for a particular user or organization. An organization could also be allowed by the host system 102 to use the scores for marketing purposes.

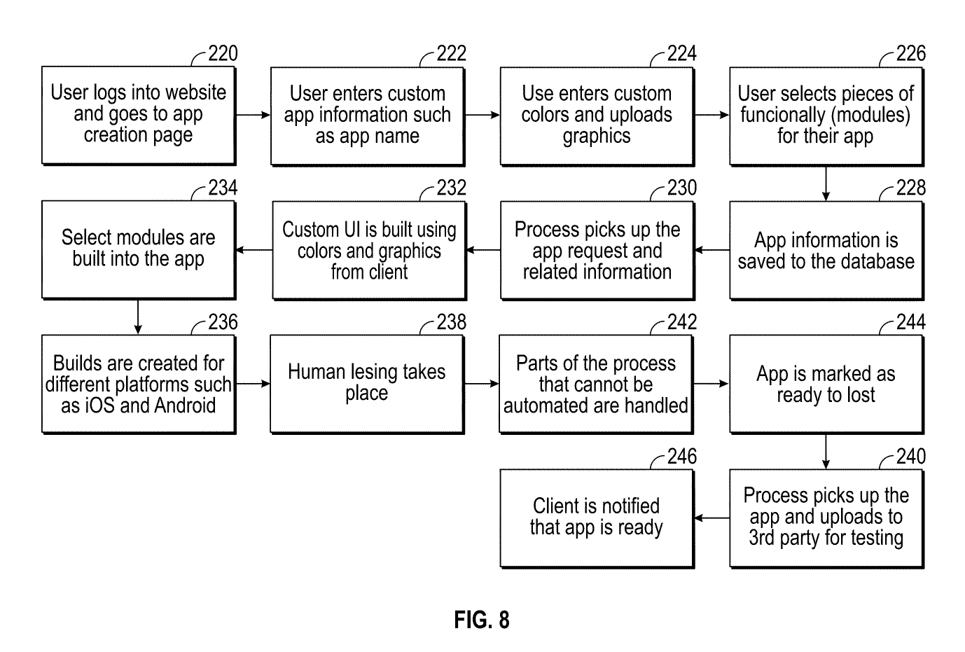

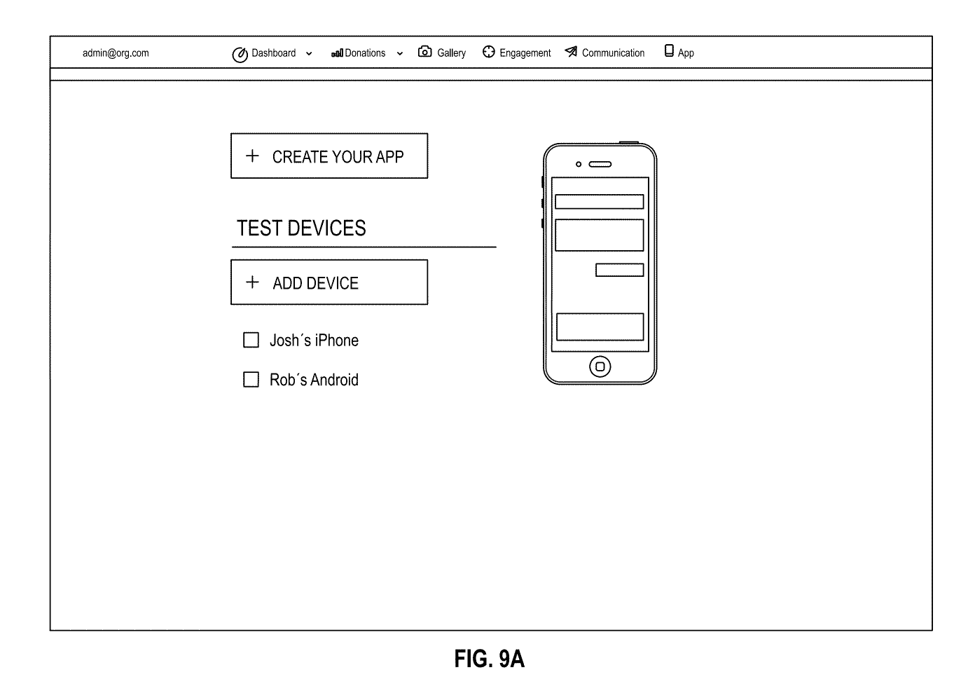

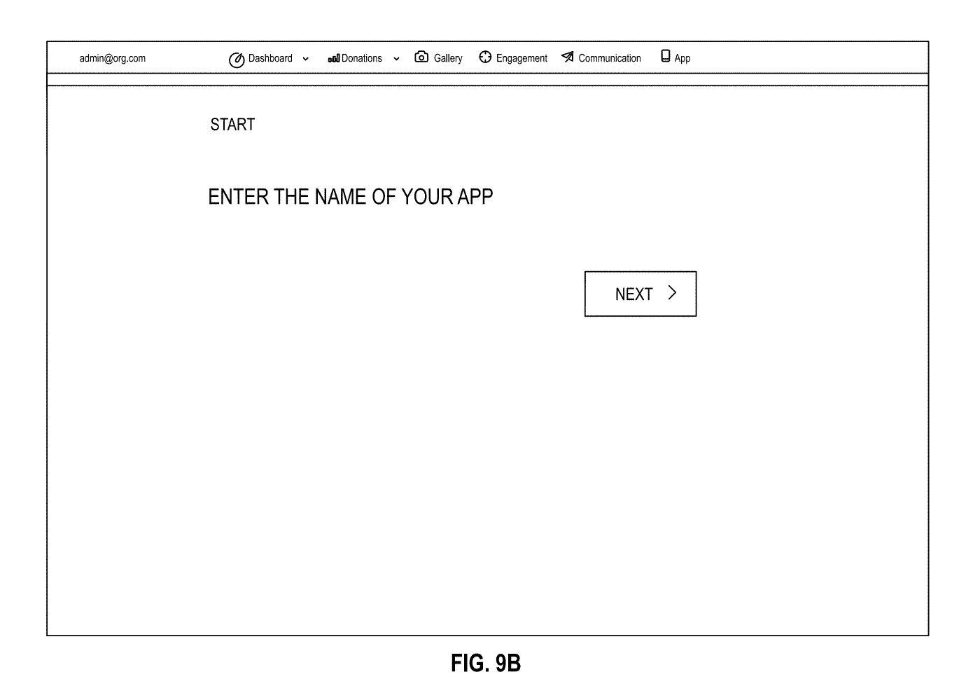

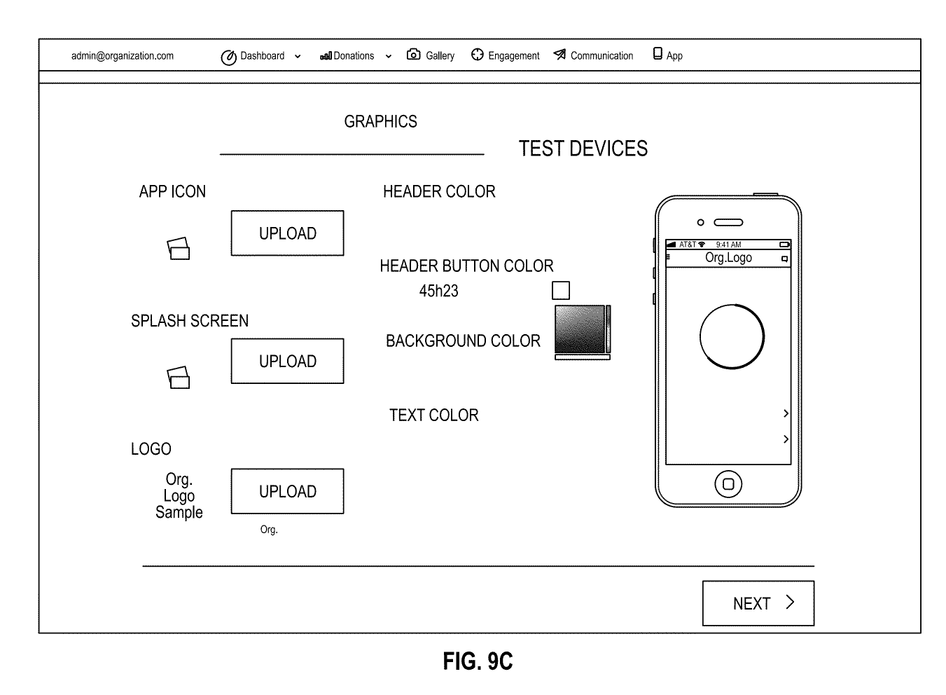

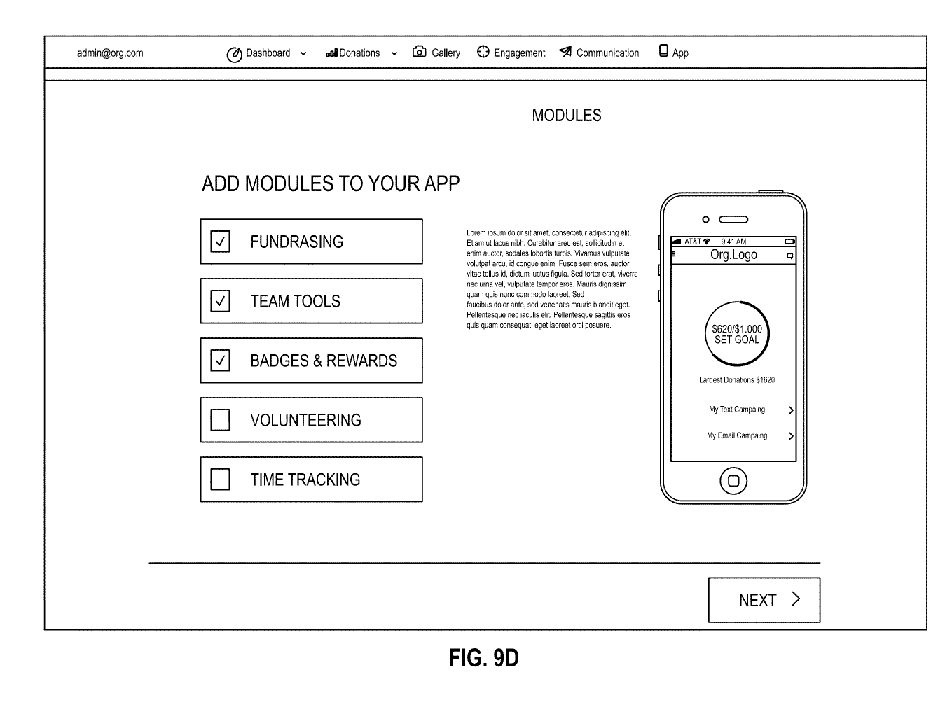

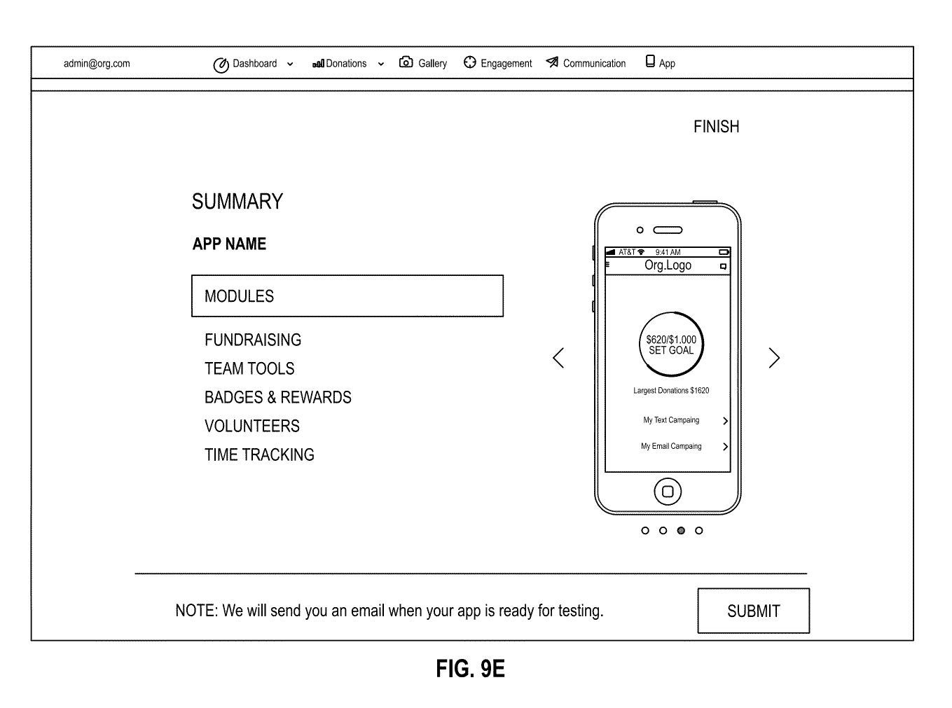

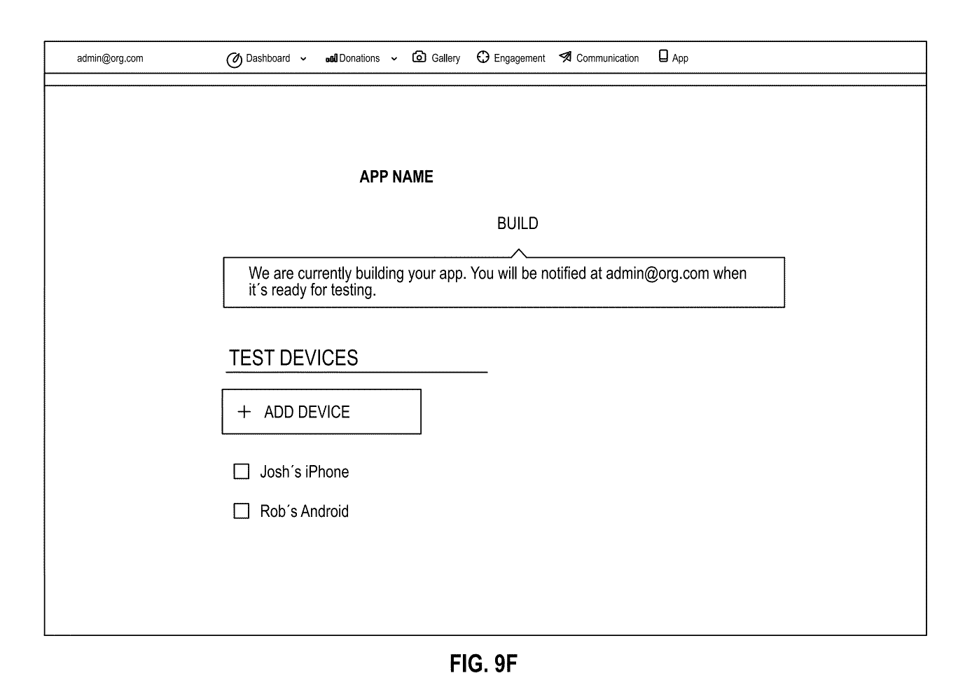

Referring now to FIGS. 8-9F, in some embodiments, the host system 102 may execute event application creation automation logic to allow users such as charitable organizations to automatically create custom event applications.

For example, a user (e.g., representative of a charitable organization) may access the host system 102 such as by logging into a website provided by the host system 102 as an administrator and may be presented with a dashboard-type web page or website as indicated by a block 220. For example, an administrator may be provided with a web form to fill out information related to the desired event application the administrator wishes to build. The administrator may fill out information such as (but not limited to) event application name (see block 222), colors and graphics (see block 224), and different modules (e.g., pieces of functionality as described above including, but not limited to an event participant module, a fundraising module, a recruitment module, and a multi-channel communication aggregate module) as indicated by block 226. The host system 102 may store the information provided by the administrator in the event database 126 as indicated by a block 228. An automated logic stored in the memory 110 may be executed by the processor 108 to initiate the charitable event application creation process as indicated by a block 230.

The charitable event application creation process may include customizing a user interface based on graphics and colors uploaded or selected by the administrator as indicated by a block 232. The process may also build in one or more different modules selected by the user as indicated by a block 234 and create any appropriate database records. In some embodiments, the process may create builds for different platforms such as iOS and Android as indicated by a block 236. In some embodiments, the host system 102 may optionally notify appropriate quality control personnel which may access the automatically-built event application and test and approve the functionality of the event application as indicated by a block 238. In some embodiments the event application may be optionally uploaded to a third party application testing service by the host system 102 as indicated by a block 240. In some embodiments, quality control personnel may also fill in any gaps that were not be automated by the host system 102 as indicated by a block 242 and then mark the event application as ready to test as indicated by a block 244. The host system 102 may provide the approved or finalized event application to the respective user such as by uploading the event application to the respective user's computing device 104, or by notifying the user (e.g., via email) that the event application is complete and/or sending download link, instructions and/or authentication credentials to the user to enable the user to obtain the event application as indicated by a block 246.

In some embodiments, the host system 102 may obtain or extract the desired information from emails, user websites, or the information may be manually input by a customer service personnel talking on the phone with a user. Further, any desired client application service may be implemented to test charitable event applications. Additionally, one or more preconfigured or generic colors, graphics, or user interface packages or themes may be provided for user selection. In some embodiments, varying preconfigured sets of modules or functionalities may be provided to users by the host system 102, depending on the type of charitable event or other application the users wish to build. For example, if a user wishes to build a marathon application, the host system 102 may automatically provide the appropriate modules for a marathon-type event application.

In some embodiments an event application according to the inventive concepts disclosed herein may include processor executable code stored in a non-transitory processor-readable medium and executed by the computing device 104 implemented as a smartphone and/or a tablet configured to exchange data with the host system 102 over the network 106. As will be appreciated by persons of ordinary skill in the art, the event application may cause a processor of the computing device 104 to carry out the logic described herein and to exchange data or signals via the network 106 with another computing device 104 and/or with the host system 102 to carry out the functionality described herein.

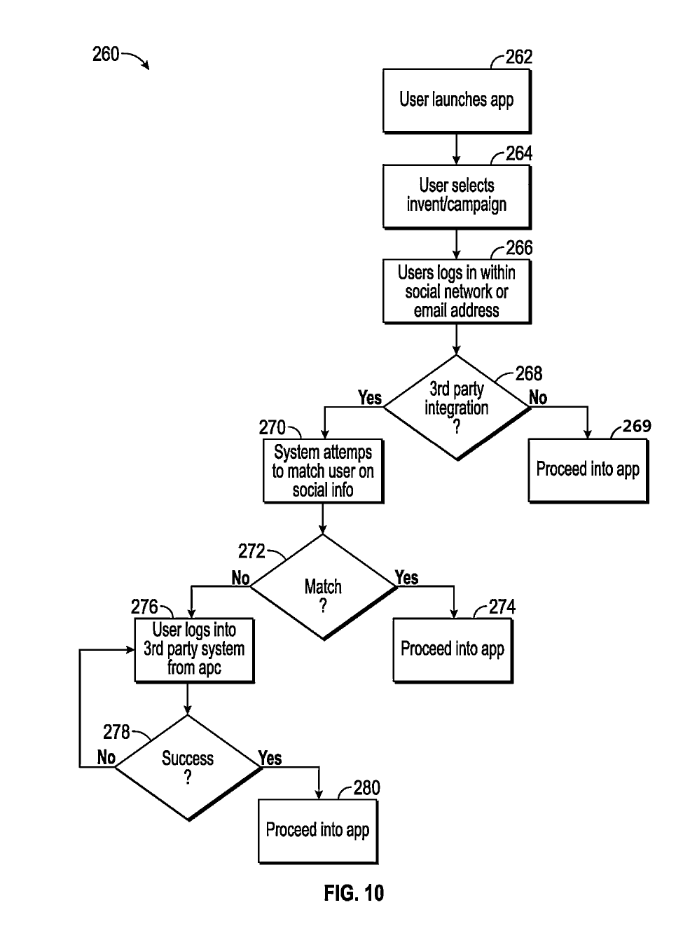

Referring now to FIG. 10, shown therein is an embodiment of a user login logic flow 260 of an event application executed by the computing device 104. When launched by the user as indicated by block 262, the event application may cause the processor of the computing device 104 to provide a user with a list of events or campaigns via the output device 124, for example.

The list of events or campaigns may be controlled by an organization or entity (e.g., a charity or non-profit organization) and may be sorted by date, time, and/or location (e.g., relative to a location of the computing device 104). For example, the event application may carry out a distance calculation to find and display events within a certain distance from the computing device 104 and may obtain the appropriate list from the host system 102. The user may activate one or more elements or features of a user interface (e.g., via the input device 122) to select one or more event/campaign from the list. In some embodiments where a single event or campaign is available, this step may be omitted.

In response to the user selection of an event or campaign as indicated by block 264, the event application may cause the computing device 104 to provide a login screen to the user via the output device 124, for example as indicated by block 266. In some embodiments, the user may login to the event application using a social network login screen and social network (e.g., Facebook, or Twitter) credentials, or the user may be allowed to login by providing a user name and an email address and/or a password or other unique identifier.

In response to the user being successfully logged in or authenticated via any desired third party authentication service or method, the event application may cause the computing device 104 and/or the host system 102 to determine whether third party integration exist for the event of campaign selected by the user as indicated by block 268.

In response to third party integration not existing for the event of campaign selected by the user, the user may be presented with event application functionality by the computing device 104 as indicated by block 269.

In response to third party integration existing for the event or campaign selected by the user, the computing device 104 may access a third party database as indicated by block 270, such as by exchanging one or more signals via a computer port over the network 106 with the third party database (e.g., a web server, another computing device 104, or the host system 102). If the user is matched up via the third party integration as indicated by block 272, the event application may obtain any user data from the third party database and/or from the host system 102 and present the user with event application functionality as described below and indicated by block 274. If the user is not matched via the third party integration, the user may be presented with a login screen to allow the user to log in to a third party system via the event application as indicated by block 276. In response to the user being successfully logged in or authenticated with the third party login system as indicated by block 278, the user may be presented with event application functionality by the computing device 104 as indicated by block 280.

In some embodiments where third party integration is available, the social login screen may be omitted, and the user may be presented directly with a third party login screen by the event application. Further, in some embodiments where third party integration is available, the user may be matched up based on the social login screen where data of third party users is available to the computing device 104 and/or can be accessed by the user terminal over the network 106. In some embodiments, the third party login may be omitted and users may log in to a third party system after social login.

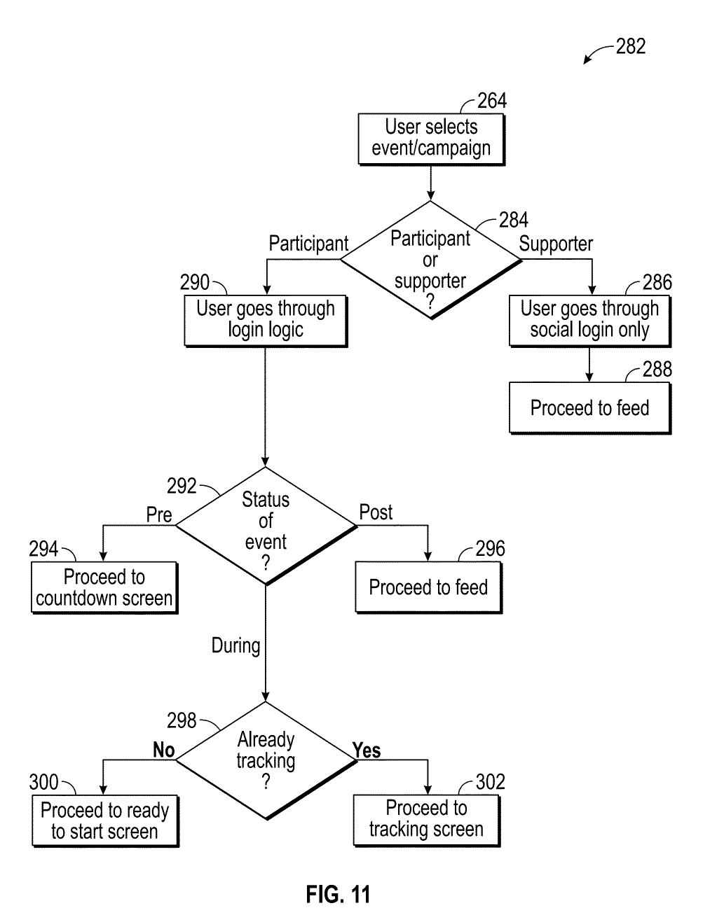

Referring now to FIG. 11, shown therein is an embodiment of an event participation functionality 282 of an event application according to the inventive concepts disclosed herein.

In response to the user's selected campaign or event as described above with reference to block 264, or in response to an event or campaign in which the user participates, the event application may determine if the user is a participant in the respective event, or a supporter of another participant in the event as indicated by a block 284.

Where the user is determined to be a supporter of another participant in the campaign or event, the event application may present the user with the social network login screen as indicated by block 286 as described above, and after successful login or authentication may present the user with an activity feed interface as described below and indicated by a block 288.

Where the user is a participant, the event application presents the user with logic as indicated by a block 290 and may optionally determine the status of the event or campaign as indicated by a block 292. For example, where the campaign or event has not started yet, the user may be presented with a countdown screen indicative of time remaining to event or campaign start as indicated by a block 294. Further, where the event or campaign has ended as indicated by a block 296, the user may be presented with the activity feed interface as described below. Where the event or campaign is ongoing, the event application may determine if the user is tracking their participation in the event or campaign as indicated by block 298. In response to the user not tracking their participation, the event application may present the user with a user interface allowing the user to start tracking their participation in the event as indicated by block 300. If the user is already in tracking mode during the event or campaign, then the event application may provide the user with an event tracking interface as indicated by block 302.

It is to be understood that in some embodiment, each user may be designated as a participant by default, and the supported determination may be omitted. Further, in some embodiments where an organization is running a continuous event or campaign, determining the status of the event or campaign may be omitted and the event application may proceed with determining whether the user is tracking their participation. Additionally, in some embodiments, the event may not have a tracking option, and the tracking-related steps may be omitted.

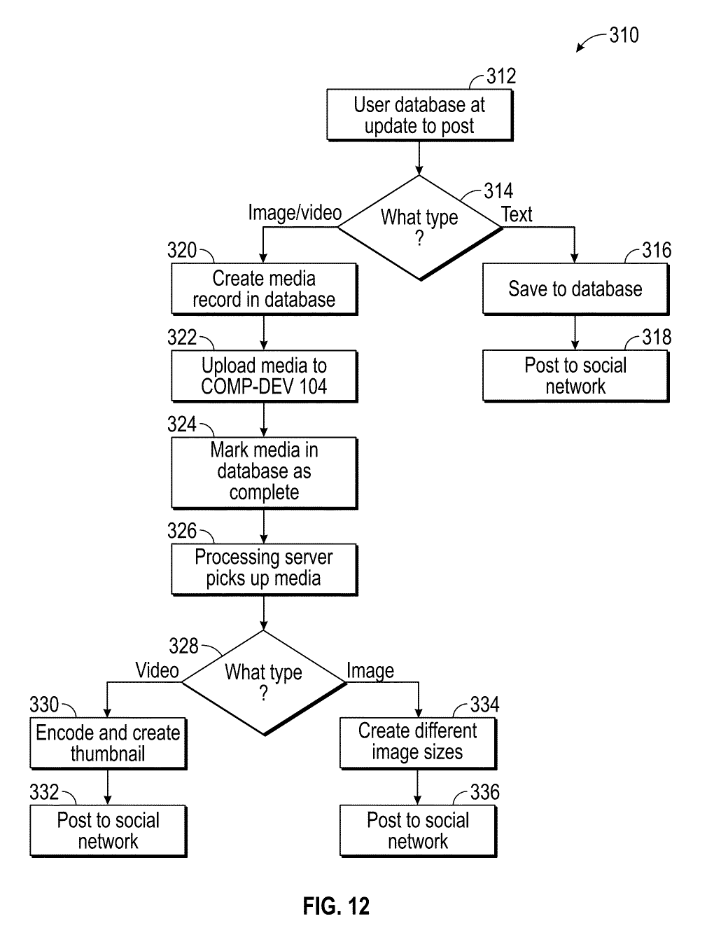

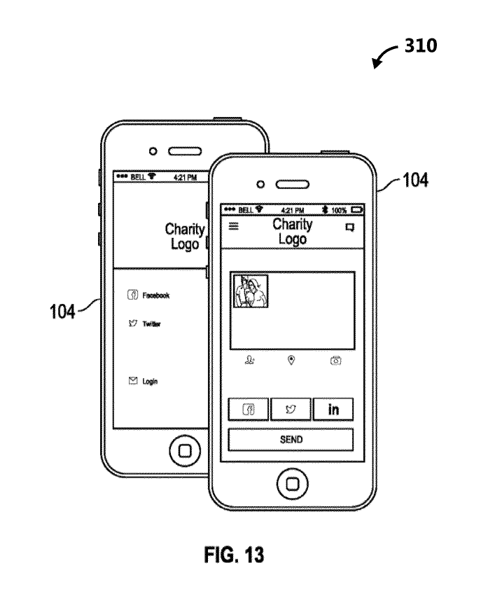

Referring now to FIGS. 12-13, shown therein is a social posting functionality 310 of an event application according to the inventive concepts disclosed herein. As indicated by block 312, the user may enter an update to post to any desired social network or website via one or more user interfaces provided by the event application.

The event application may determine a type of the post, as indicated by a block 314, e.g., if the user is posting a text-based update, or an image/video based update. In response to determining that the update is a text update, the event application may cause the computing device 104 to store the text update in a non-transitory processor readable medium, or to transmit one or more signals indicative of the text update to a database such as the event database 126 over the network 106 as indicated by a block 316. The event application may post the text update to the selected social network via any appropriate third party integration or authentication, such as by transmitting one or more signals to the host system 102 or to another computing device 104 over the network 106 as indicated by block 318.

In response to determining that the update is an image or video update, the event application may create and store a record indicative of an image or video update being uploaded to a social network by the user as indicated by block 320. In some embodiments the image or video update may be stored in a local media database by the computing device 104 as indicated by block 322 and/or may be transmitted to the host system 102 over the network 106. In some embodiments, the image or video update may not be stored locally, and may be transmitted to a third party or remote web server or database via the network 106.

Where the image of video update is transmitted to a remote database, the record indicative of an image or video update being uploaded to a social network by the user may be updated with appropriate fields that the upload is complete as indicated by block 324. In some embodiments, the host system 102 may receive the image or video update from the user terminal and may process the media as desired as indicated by block 326. For example, images or photographs may be resized, have their resolution changed, reformatted, etc. Further, video files may be encoded, edited, or a thumbnail image of each video file may be created by the host system 102. The host system 102 may transmit one or more signals to the computing device 104 over the network indicative of the media that was uploaded to the social network selected by the user.

It is to be understood that any desired web server, remote database, or cloud hosting service may be used to store relatively large media such as images, pictures, or video files. Further, the media may be processed by any desired processing methods, or may be stored unprocessed in some embodiments. Further, in some embodiments media may be processed locally by the computing device 104 prior to being uploaded to the host system 102 or to a remote database, and the processing, uploading, and event application notification steps may be carried out in any desired order or sequence. In some embodiments, the event application and/or the host system 102 may determine what type of media is desired to be uploaded to the social network as indicated by a block 328. For example, if the type of media desired to be uploaded to the social network is a video, the event application executed by the computing device 104 and/or the host system 102 may create a thumbnail as indicated by block 330, and then post the video to the social network as indicated by block 332. If the type of media desired to be uploaded to the social network is an image, the event application executed by the computing device 104 and/or the host system 102 may create a multiple different image sizes as indicated by block 334, and then post at least one of the images to the social network as indicated by block 336.

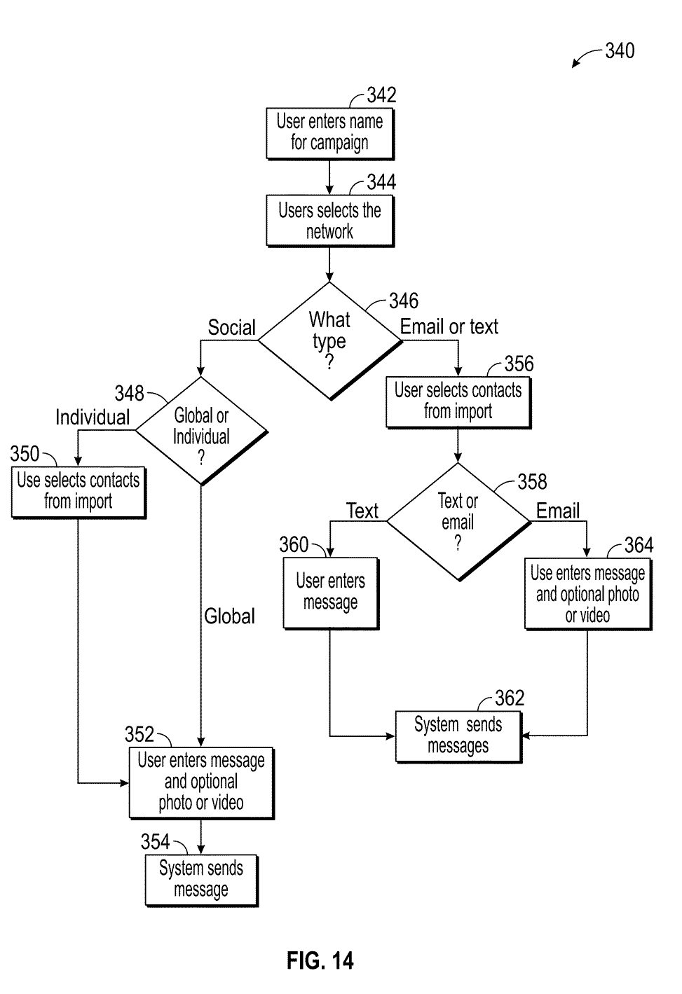

Referring now to FIG. 14, shown therein is an embodiment of a peer-to-peer fundraising logic 340 of an event application according to the inventive concepts disclosed herein. In some embodiments, the event application may allow users to create peer-to-peer fundraising campaigns. For example, users may create peer to peer fundraising campaigns and send donation links or other information to their contacts. The event application may provide a user with user interface allowing the user to create and/or name a campaign as indicated by a block 342.

In response to the user naming their campaign, the user may be presented with a user interface allowing the user to select a social network (e.g., Facebook, Twitter, LinkedIn, Email, and/or Text) as indicated by block 344. If desired, the user may authenticate with the social network that was selected. The event application may pull in the user's contacts from whichever social media, email, or other channel the user selected. When creating peer-to-peer fundraising campaigns, the peer-to-peer fundraising logic 340 may prompt the user for which type of network that the user would like to send donation links or other information to their contacts as indicated by block 346.

In some embodiments indicated by block 348, the user may be provided with an option on social networks to post globally (e.g., as a publicly readable or accessible update or post). If the user chooses a global post, the contact selection may be skipped by the event application. If the users select an individual option, the user may be allowed to select which contacts to send a message to or share a link or item with as indicated by block 350. The user may compose or enter the message and optionally attach media such as a photo, an image, or a video file as indicated by block 352. The event application may send the message depending on the type of social network selected, such as by transmitting one or more signals over the network 106 to the host system 102 or to other computing devices 104 executing the event application as indicated by block 354.

If the user selects a type of network other than the social network to send a donation link at the block 346, the peer-to-peer fundraising logic 340 may branch to a block 356 where the user selects particular contacts to send the donation link, and then the peer-to-peer fundraising logic 340 branches to a block 358 to prompt the user to select a communication methodology for sending a donation link. For example, if the user selects text messaging as the communication methodology, the peer-to-peer fundraising logic 340 branches to a block 360 where the user enters a text message and the peer-to-peer fundraising logic 340 sends the text message at block 362. As another example, if the user selects email as the communication methodology the peer-to-peer fundraising logic 340 branches to a block 364 where the user is prompted for the message and the donation link followed by the peer-to-peer fundraising logic 340 sending the message as indicated by the block 362.

In some embodiments, rather than or in addition to sending a donation link, the user may simply post an update of their participation in an event or of their support of another user participating in an event (e.g., a charity event). Any desired number of social networks, websites, blogs, or any other desired communication channel of medium may be added to the above process. It is to be appreciated that the peer-to-peer fundraising functionality may be provided to users of the host system 102 in some exemplary embodiments.

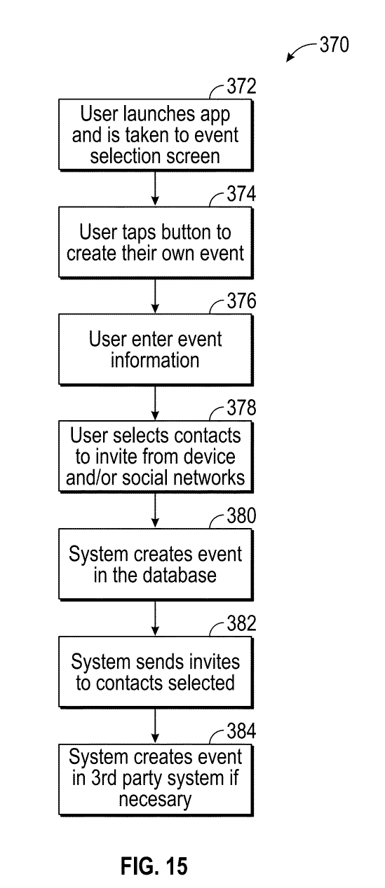

Referring now to FIG. 15, in some embodiments, the event application may provide users of the computing device 104 with event creation functionality to enable users such as event participants to create an event or a fundraising campaign and invite contacts to join them. Events created by users via the event application may be activity based or simply a fundraising page for a charitable or other organization. A user may be provided with a list of events by the event application as indicated by block 372. The list of events screen may include a user-selectable interface such as a button allowing the user to create an event as indicated by block 374. In response to the user selecting the interface, as indicated by block 376, the user may be provided with one or more screens allowing the user to enter information related to their event including, but not limited to, name, date, type, location, or any other desired information. The computing device 104 creates the event with user-provided information, and the user is provided with one or more user interfaces or screens to allow the user to invite contacts stored on the computing device 104 and/or from one or more social network where the user has an account to join the event as indicated by block 378. In some embodiments, the event application may provide users with similar functionality to the functionality provided with organization or host system 102 created events. For example, the event application may create events in the event database 126 by sending signals across the communication network 106 as indicated by block 380, the event application may send invitations to the contacts that are selected as indicated by block 382, and the event application may also create an event in third party systems as indicated by block 384. In cases where the host system 102 or the computing device 104 is integrated with a third party event system, the host system 102 or the computing device may export any desired information and may create the event in the respective third party event system (e.g., via an API).

It is to be understood that in some embodiments the event creation functionality may be provided to users via a website or webpage provided or maintained by the host system 102 and/or via the computing device 104. Further, in some embodiments, the event list presentation screen may be omitted, and the user may begin creating an event once logged into or authenticated by the event application. In some embodiments, users may create events in third party event systems and may import a partially or completely created event into the host system 102 and/or into the computing device 104, where the event may be accessed and ran or managed through the event application as described herein.

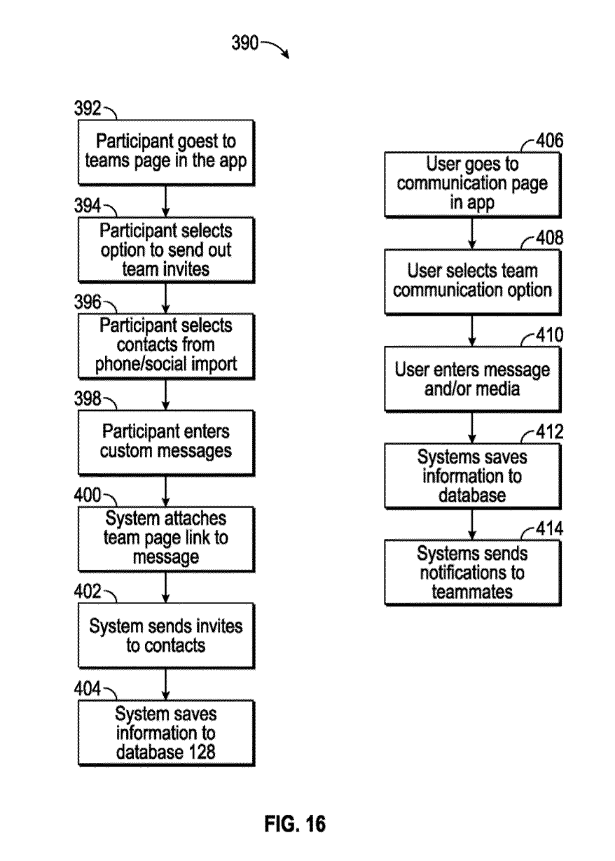

Referring now to FIG. 16, shown therein is team functionality and communication logic 390 according to some embodiments of an event application according to the inventive concepts disclosed herein. The computing device 104 executing the event application may provide users with one or more user interfaces as indicated by block 392 allowing users such as event participants to invite contacts to join a team and to communicate with team members as indicated by block 394. The user may enter a custom message as indicated by block 398 and the event application may also attach a team page link to the message as indicated by block 400. The event application sends the invitation to the selected contacts as indicated by a block 402, and then send signals over the communication network 106 to save the information in the user database 128 as indicated by block 404. In some embodiments, team information may be obtained (e.g., via the network 106) from third party systems and may be displayed to users in the event application. In some embodiments, when a user sends out team invitations to users, the computing device 104 and/or the host system 102 may attach links to the third party signup page.

A user can send invites out to any contact stored on the computing device 104 and also on one or more social networks where the user has accounts as indicated by block 396.

Once one or more teams have been formed due to users accepting the invitation to the team member, the event application includes functionality to permit the team members to communicate through the event application. For example, the event application may provide a communication page to a team member as indicated by block 406. The team member would then select a team communication option provided on the communication page as indicated by block 408. The team member would then enter a message and/or media to be communicated to the other team members as indicated by block 410. Thereafter, the event application sends signals over the communication network 106 to save the information in the user database 128 as indicated by block 412, and then communicates the message and/or media to the other team members as indicated by block 414. When a user sends out a team communication to teammates using the event application (e.g., other users of computing devices executing the event application), the selected teammates may receive push notifications via their respective event applications and may be able to view the conversation in an event application feed screen or user interface. In some embodiments, teams may be created locally by each event application and/or by the host system 102.

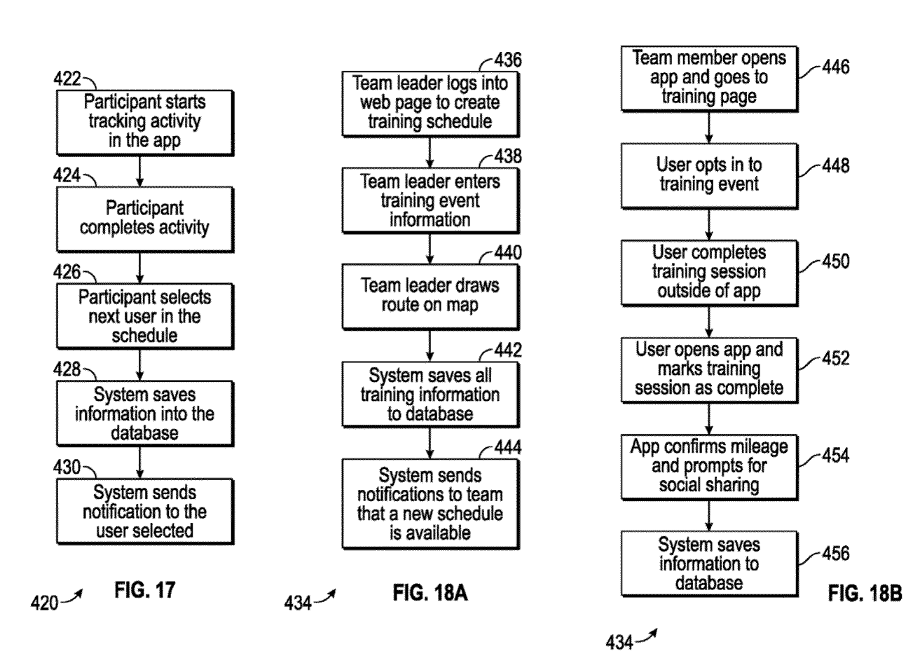

Referring now to FIG. 17, shown therein is an embodiment of a virtual handoff functionality 420 provided to users by an event application according to the inventive concepts disclosed herein. The virtual handoff functionality 420 may allow organizations to run team based events across the world and may create a broader level of engagement for users. A team schedule may be imported into the host system 102 from a third party system in some embodiments. A user may launch the event application and may start tracking an event activity as indicated by block 422. When the user's activity is done as indicated by block 424, the user may activate a user-selectable interface provided by the event application (e.g., a complete button). In response, the event application may provide a virtual handoff screen to the user. The virtual handoff screen may include a list of the user's teammates and respective timeslots for the user's teammates for the respective event. The user may select a person from the list and may activate a handoff user-selectable interface (e.g., a Handoff button) as indicated by block 426. The host system 102 and/or the computing device 104 may save the respective information as indicated by block 428 and may provide the selected user with a notification via a respective computing device 104 notifying the user it is their turn to participate in the event as indicated by block 430.

In some embodiments team schedules may be created by users or organizations in the host system 102 (e.g., via a dashboard or web site) and/or the computing device 104, and users may be provided with a list of other users or teammates that have not yet participated in the event. In some embodiments, the user may be presented with the nest person on the list based on a timeslot, for example. Further, the selected user may not be notified in some instances.

Referring now to FIG. 18A-18B, in some embodiments users may be provided with event training functionality 434 by the event application. Referring now to FIG. 18A in particular, a user (e.g., a team leader) may log into a web page or dashboard provided by the host system 102 and may create a training schedule for members of the respective team as indicated by block 436. The training schedule may include information about training events as indicated by block 438 along with ability to create routes for training events as indicated by block 440. The host system 102 may store the training schedule in the event participant database 128, for example as indicated by block 442 and then sends notifications to the team members that a new schedule is available as indicated by block 444.

Referring now to FIG. 18B, when a team member opens the event application on the computing device 104 and navigates to a training screen or page of the event application as indicated by block 446, the training information may be downloaded to the computing device 104 from the host system 102 and displayed to the user. The user may opt in/out of training sessions as indicated by block 448 and may see other team members who have opted in or out in some instances. Users may also view the proposed route in a map, for example.

In response to a user completing or ending a training session as indicated by block 450, the user may launch the event application and mark that training item as complete as indicated by block 452. The event application may confirm the mileage completed as indicated by block 454 and may transmit the data to the host system 102, which may store the data in the user database 128, for example as indicated by block 456. The event application may prompt the user to share their training on social networks to help fundraise and raise awareness, in some embodiments.

It is to be understood that individual users who are not members of a team may be provided with the above functionality. Further, users may not be able to opt in or out of training sessions or events. In some embodiments, a training session may be created without a mapped route, and a user creating the schedule may enter the distance desired and/or may upload a map or image of a proposed route for viewing by team members or other users. In some embodiments training sessions and charity events may include distance-based activities, such as runs, marathons, walks, swims, hikes, climbs, biking, or combinations thereof, and in some embodiments training sessions or charity events may include stationary activities. Further, in some embodiments the event application may automatically track and record the user's activity or mileage and may automatically transmit the associated data to the host system 102 and/or to an integrated third party system.

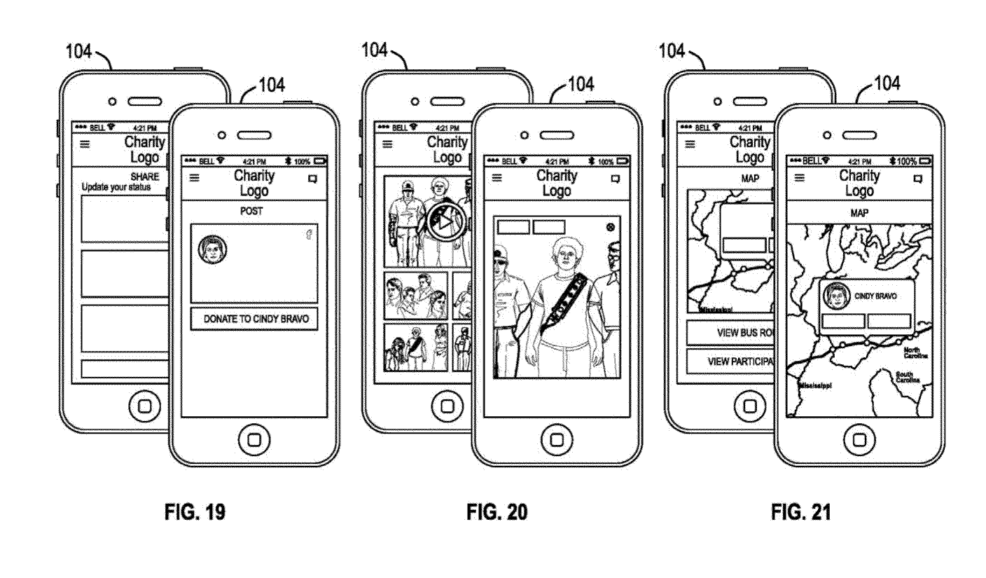

Referring now to FIGS. 19-31, in some embodiments, event applications according to the inventive concepts disclosed herein may provide users of computing devices 104 with event map replay and timeline functionality.

For example, the host system 102 and/or the computing device 104 may store spatial information (latitude/longitude) with data associated with events or users to allow the host system 102 and/or the computing device 104 to display event activity on a map. In some embodiments the information may be layers into any desired number of layers such as: users, donations, and social activity layers, for example. The information may be displayed to a user of the host system 102 via a dashboard, or may be provided to users of computing devices 104 via the event application as described herein. Scores calculated by the host system 102 for different items may be used to create weighted circles on the map and display the weighted circles to users to allow users to spatially observe where impact is occurring on the map. While weighted circles are described herein, it is to be understood that any desired graphical user interface element, color, or feature may be implemented with the inventive concepts disclosed herein, such as icons, avatars, activity indicators, user pictures, charity logos, team logos, team names, user names, or combinations thereof. In some embodiments, heat maps or color ranges (e.g., having the same or different sizes) may be implemented to show levels of impact. Any number of layers may be used, and the layers may reflect any desired granularity. Further, layers for photos, videos, participants, supporters, or any other desired information may be added. In some embodiments, different social networks may be incorporated as different layers.

Organization representatives or other users of the host system 102 may be provided with the ability to filter the map data based on dates. The host system 102 may create a timeline from event start to event finish and may plot points on the days that activity occurred. The dots may be colored from cold (blue) to hot (red) based on the level of activity that happened (e.g., based on scoring as described above). This allows the organization to see which days were the most impactful. A user can click on a dot on the timeline and filter the data shown on the map to what is relevant for that particular date in some embodiments. In some embodiments, numerical indicators may be user instead of, or in addition to colors.

In some embodiments, the host system 102 may give organizations the ability to replay events in a map using play/pause functionality. A user can pause the replay at a given point and specify any desired amount of time and view data during that time range. This allows organizations to play out event and dissect data at certain points to understand what is happening and when so as to better evaluate user engagement.

Referring now to FIG. 19, in some embodiments an event application may be executed on the computing device 104, which may be implemented as a smartphone, and may provide a user such as an event participant, a supporter of an event participant, a member of the public, or a representative of an organization hosting or holding an event, with a variety of user interfaces and functionality. For example, a user interface may be provided which includes a name and/or logo of an organization holding an event. Further, if a user has logged in or has been authenticated by the event application as described herein, the user may be provided with functionality allowing the user to view posts, photos, videos, or other media or items shared by other users, participants in the event, supporters, or organizations. Such items may be shared on one or more third party social networks, websites, or channels, or may be shared via the host system 102 and/or via the event application in some embodiments.

Referring now to FIG. 20, in some embodiments event applications according to the inventive concepts disclosed herein may provide users of the computing device 104 with user interfaces and/or functionality enabling the user to view, interact with (e.g., like, comment, or share) videos, photos, status updates, or other media or items, shared by other event participants, supporters of event participants, or organizations or other users. For example, the event application may provide the user with social media or other shared items relating to the event pulled from one or more third party sources by the host system 102 and transmitted to the computing device 104 via the network 106.

Referring now to FIG. 21, shown therein is an example of an interactive map for event participants using the event application to view event routes and other participants in the event. The map may allow users to donate to, encourage, or otherwise support other event participants by interacting with one or more features or layers on the interactive map. The interactive map may include any desired data layers, and may allow users to zoom in, select, view, change, or otherwise interact with an event route. Users may be allowed to view all or some event participants, or view bus routes or other routes relating to a route-based event such as a walk, a run, a marathon, a parade, a hike, a swim, or combinations thereof.

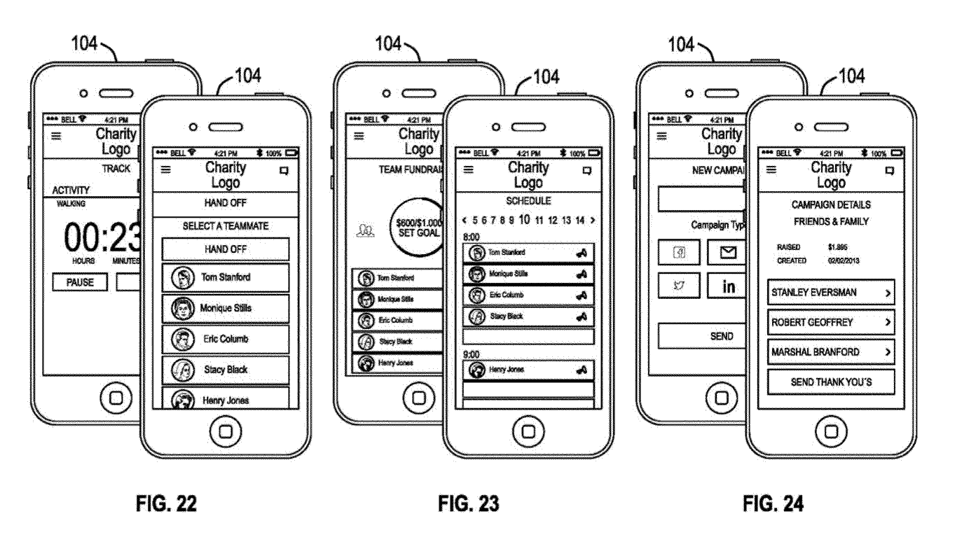

Referring now to FIG. 22, shown therein is an exemplary embodiment of activity tracking functionality provided to users of an event application according to the inventive concepts disclosed herein. The event tracking functionality may include one or more user interfaces such as timers, distance indicators, calorie counters, milestones, progress bars or other progress indicators, or sponsoring organization logos or other messages. In some embodiments, the event application may allow users to handoff activity to team members as described above. For example, the user may be presented with a list of teammates or other users or event participant, including respective timeslots for each teammate. The user may be allowed to select one or more teammate or other user, and to hand off activity to the selected teammate or user by activating a hand-off user selectable interface.

Referring now to FIG. 23, shown therein is a team functionality provided by an event application according to some embodiments of the inventive concepts disclosed herein. The team functionality may allow a user or an event participant to view a team roster or list including one or more teammates, recruit other event application users or other persons as team members, encourage, donate to, or otherwise support one or more teammates (e.g., by interacting with a cheer or encourage icon or user-selectable interface), or to view and/or edit team schedules, such as training schedules or timeslots for team members during the event. Further, the user may be allowed to schedule, order, and/or reorder team members for event participation, and may show one or more progress indicators indicative of team or individual team member progress towards a predetermined goal (e.g., a donation goal, a distance goal, a timed activity goal, or combinations thereof). The progress indicators may be progress bars, progress rings, progress circles, colored indicators, or any other desired indicators, as will be appreciated by a person of ordinary skill in the art having the benefit of the instant disclosure.

Referring now to FIG. 24, shown therein is an embodiment of a peer-to-peer fundraising user interface provided to a user of an event application according to the inventive concepts disclosed herein. The peer-to-peer fundraising user interface may allow a user to engage in peer-to-peer fundraising such as by engaging one or more of the user's local or social media contacts or connections via native event application messaging, or via email, text messaging, or by using any desired third party system, platform, or social network. Users may be provided with summaries indicating fundraising campaign name, funding raised, date created, campaign types, or any other details. Further, in some embodiments users may be provided with functionality allowing users to send thank you messages to peers or funding campaign contributors, such as by using even campaign messages, emails, texts, or social media messages, or by sharing progress notes, photos, videos, or other items with contributors, or combinations thereof.

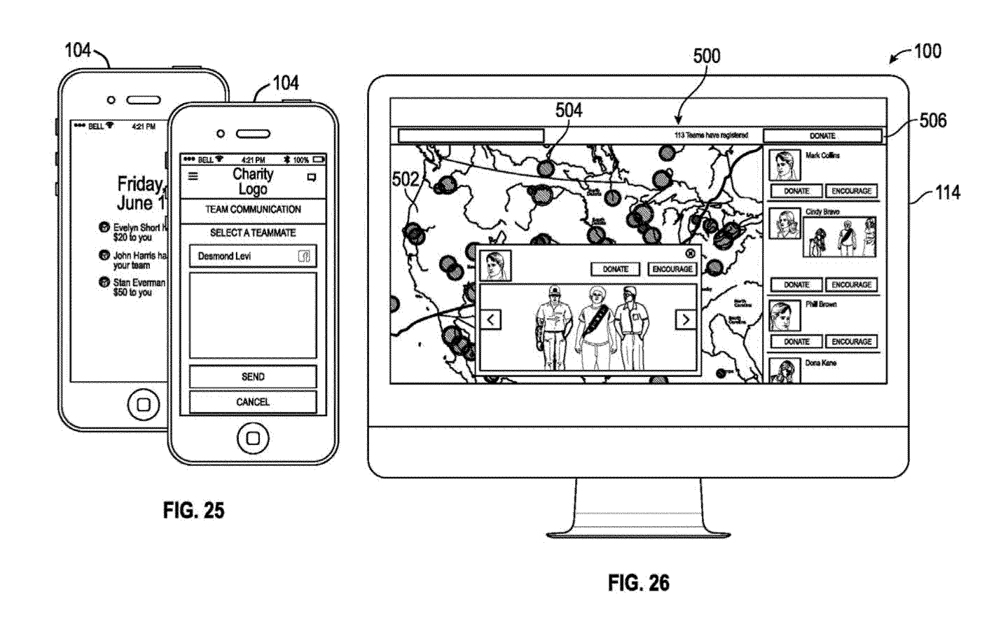

Referring now to FIG. 25, shown therein is an embodiment of fundraising notifications provided to users of computing devices 104 executing an event application according to the inventive concepts disclosed herein. The event application may provide users with one or more interfaces indicative of other users joining the user's team, or other users or supporters donating to the user (e.g., via a donation link or as part of a peer-to-peer fundraising campaign), and may allow users to send team communications or other messages to new team members or donors via the event application, or via any integrated third party application, messaging service, or social media or network, or combinations thereof. The team communications may thank users for joining a team and/or may include other information such as team names, team goals, or messages or encouragement, support, team mission, organization or charity helped, or any other desired information, or combinations thereof.

Referring now to FIG. 26, shown therein is an example of event tracking functionality provided to a user of the user engagement evaluation system 100 by the host system 102 according to embodiments of the inventive concepts disclosed herein. The event tracking functionality may be provided to users via one or more interfaces by the output device 114 in the form of a dashboard 500, for example. The user may be provided with an interactive map 502 showing one or more visual and/or interactive indicators 504 of event activity of users of the event application. Data indicative of event activities of user of event applications according to the inventive concepts disclosed herein may be transmitted to the host system 102 by one or more computing devices 104 via the network 106, and may be stored the memory 110 (e.g., in the event database 126 and/or the user database 128). The dashboard 500 may allow users to interact with one or more of the interactive indicators 504, which may open additional activity or user information, such as pictures, videos, status updates shared by a team or a user, or combinations thereof, and may allow the user to donate to or encourage a particular user or team. Further, a list of users 506 participating in an event or in a selected granularity of event activity (e.g., user-wide, social network-wide, event-wide, time-slot wide, team-wide, geographical area-wide, route-wide, or combinations thereof) may be provided to the user, and the user may be provided with functionality to donate to or encourage individual users, teams, or combinations thereof.

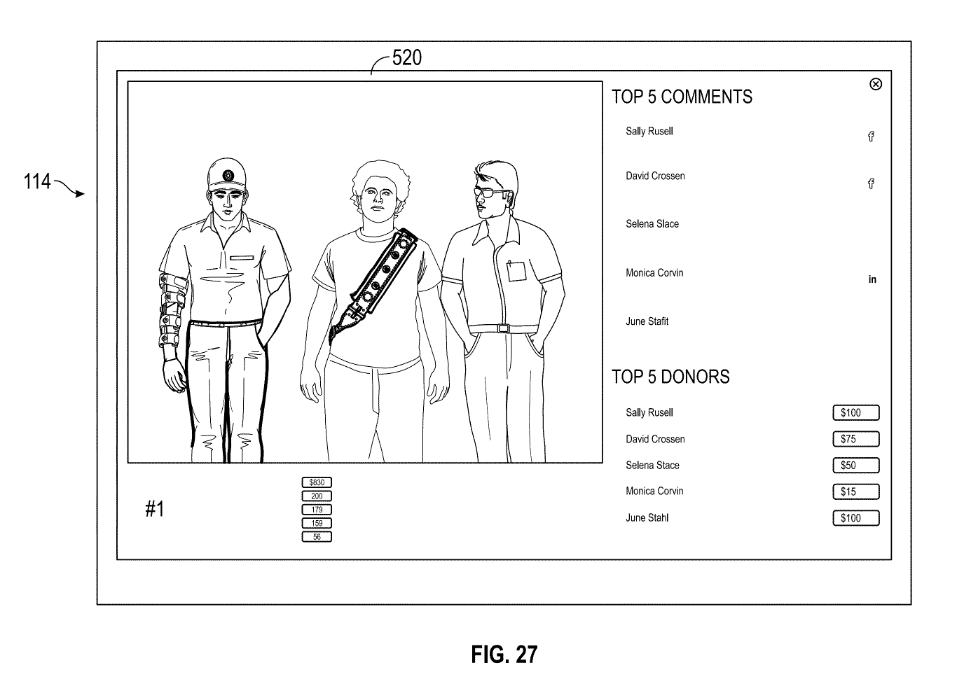

Referring now to FIG. 27, shown therein is an embodiment of a dashboard 520 provided to a user of the user engagement evaluation system 100 by the host system 102. The dashboard functionality may be provided to users of the host system 102 via the output device 114, or as a website or portal provided by the host system to one or more computing devices 104 accessing the website via the network 106, or combinations thereof. The dashboard 520 may include any desired data, at any desired granularity, and may provide a photo, video, or other social network or other item shared by an event participant, and any desired related information such as comments, shares, donors that donated as a result of interacting with the item, amount of donations generated by the item, number of clicks, likes, favourites, comments, shares, tags, of other interactions of users with the item (e.g., in the event application and/or in third party social network, donation networks, emails, text messages, or other channels). A list of top donors, top comments, top sharers, top social networks, or combinations thereof may be provided by the dashboard 520 in some embodiments. This may allow users such as organization representatives to understand and evaluate which users and which channels or items drive engagement, donations, and/or support for an event, as will be appreciated by persons of ordinary skill in the art having the benefit of the instant disclosure.

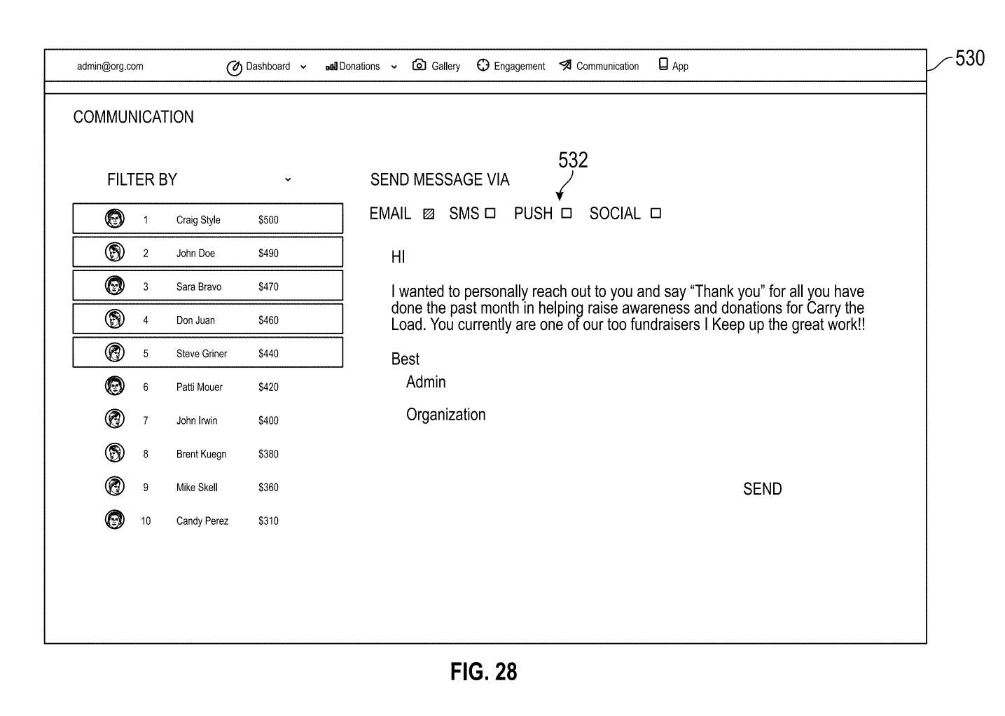

Referring now to FIG. 28, shown therein is an exemplary embodiment of a communication dashboard 530 provided to users in some embodiments of a user engagement evaluation system 100 according to the inventive concepts disclosed herein. The communication dashboard 530 may provide users with communication options 532 to send a message to users of event applications according to some embodiments of the inventive concepts disclosed herein, such as by selecting a user (e.g., from a list filtered by donation amount, event, team, or any other desired criteria) and composing a message to the user. The message may optionally by sent via an event application as described herein, or via short message, email, or any desired social network, or combinations thereof.

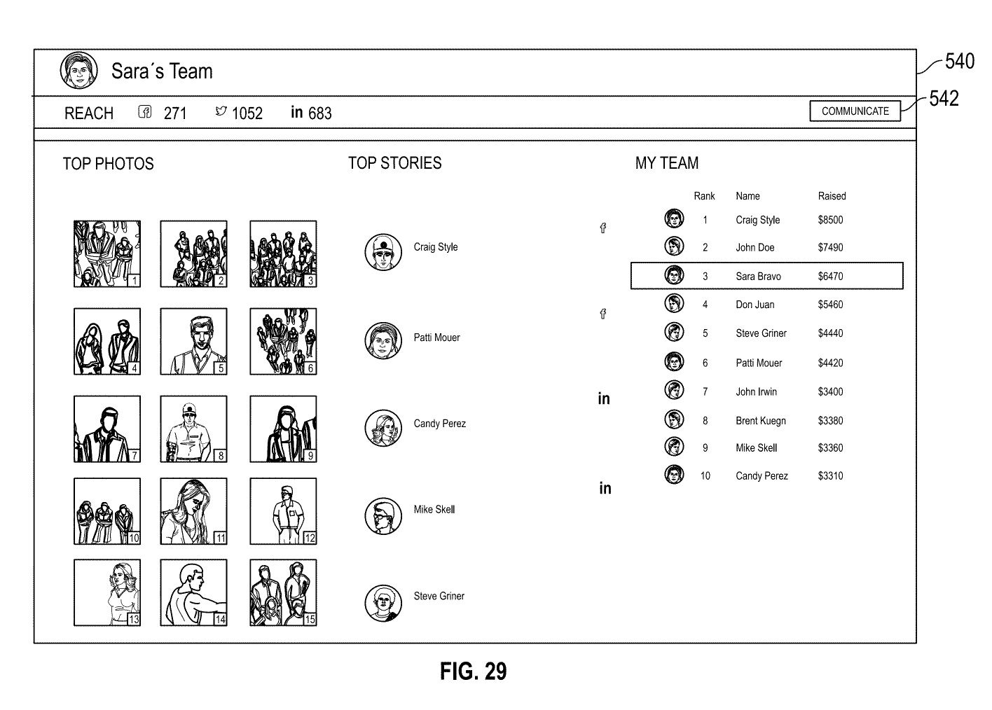

Referring now to FIG. 29, shown therein is an embodiment of a team information interface 540 provided to a user by the user engagement evaluation system 100 in some embodiments. The team information interface 540 may be a page including any desired team information such as photos, videos, messages, updates, or other items uploaded, shared, or otherwise provided by team members, top stories or social network updates by team members or supporters of the team or team members, and may rank team members based on any desired criteria, such as amount of donations raised, number or score of shared items, scores or team members as described herein, or any other desired team information. A communication interface 542 may be provided, allowing the user to communicate with one or more of the team members such as via a communication dashboard interface as described with reference to FIG. 28 above.

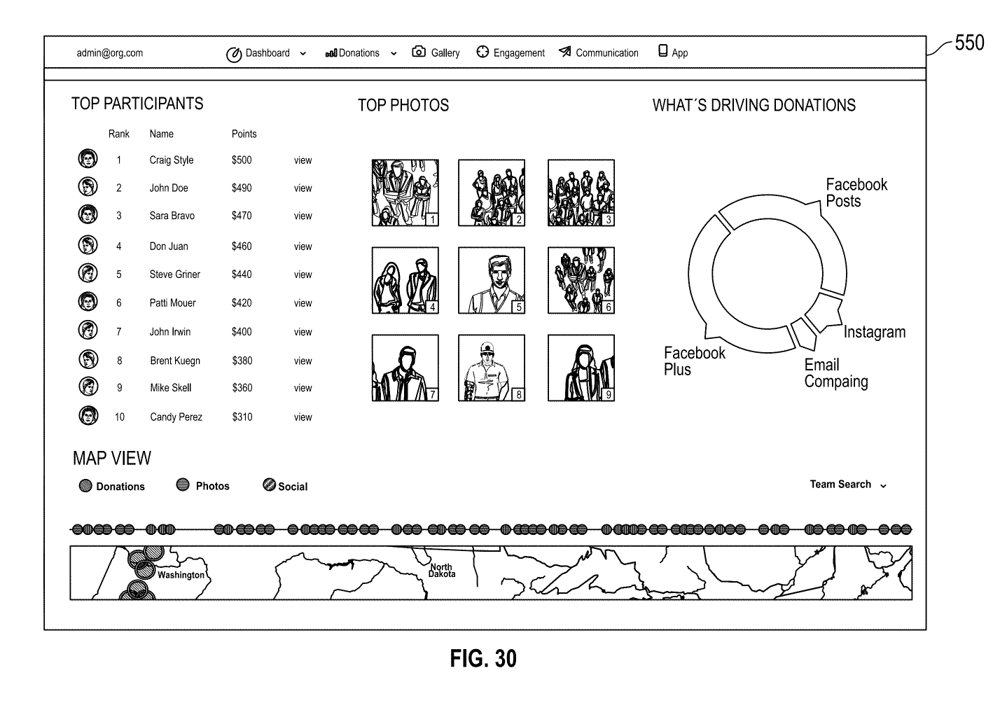

Referring now to FIG. 30, shown therein is an embodiment of donation evaluation dashboard interface 550 provided by a user engagement evaluation system 100 according to some embodiments of the inventive concepts disclosed herein. The donation evaluation dashboard interface 550 may provide event and/or user information relating to donations, such as list of users along with user scores, top photos shared by participants in an event, a visual indicator of which social network, media, or other sharing channels used by event participants drives donations for a particular event or campaign, an interactive map including interactive indicators, icons, or user-selectable interfaces indicative of spatial or temporal concentration of donations, photos, videos, or other social network posts, interactions, or impact of various event participant and/or event supporters actions.

Referring now to FIG. 31, shown therein is an embodiment of an interactive map 560 presented to users of the user engagement evaluation system 100. The interactive map 560 may allow a user to view event participant activity at any desired geospatial and temporal granularity, and may include interactive indicators 562 of user, team, donor, supporter, or any other activity relating to an event or campaign, or combinations thereof. For example, the user may interact (e.g., click, select, or hover a mouse cursor over) one or more of the interactive indicators 562, and may be presented (e.g., via an overlay, a callout box, or a pop-up) with additional information about that particular activity, such as team or user identifiers, number of photos or posts shared, number and/or amount of donations generated, and a number or other users reached by the particular user and/or team, or combinations thereof. The interactive map 560 may provide varying levels of temporal or geospatial granularity, such as by event, by day, hour, minute, by city, state, country, by month, year, campaign, or combinations thereof. Further, search or filtering functionality may be provided to allow users to search for particular users, teams, events, times, dates, countries, states, or combinations thereof.

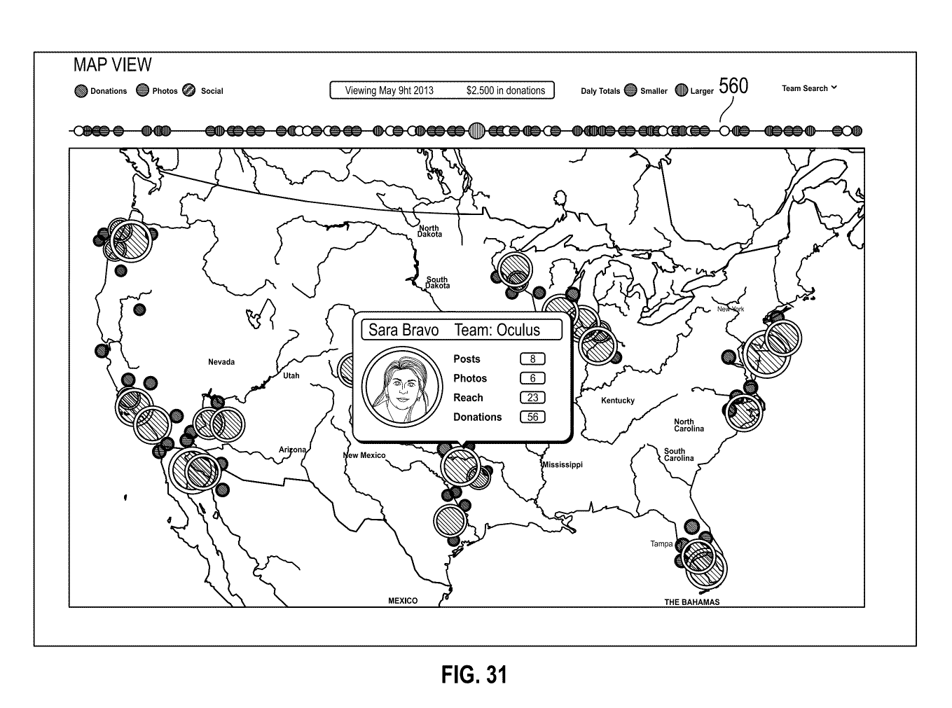

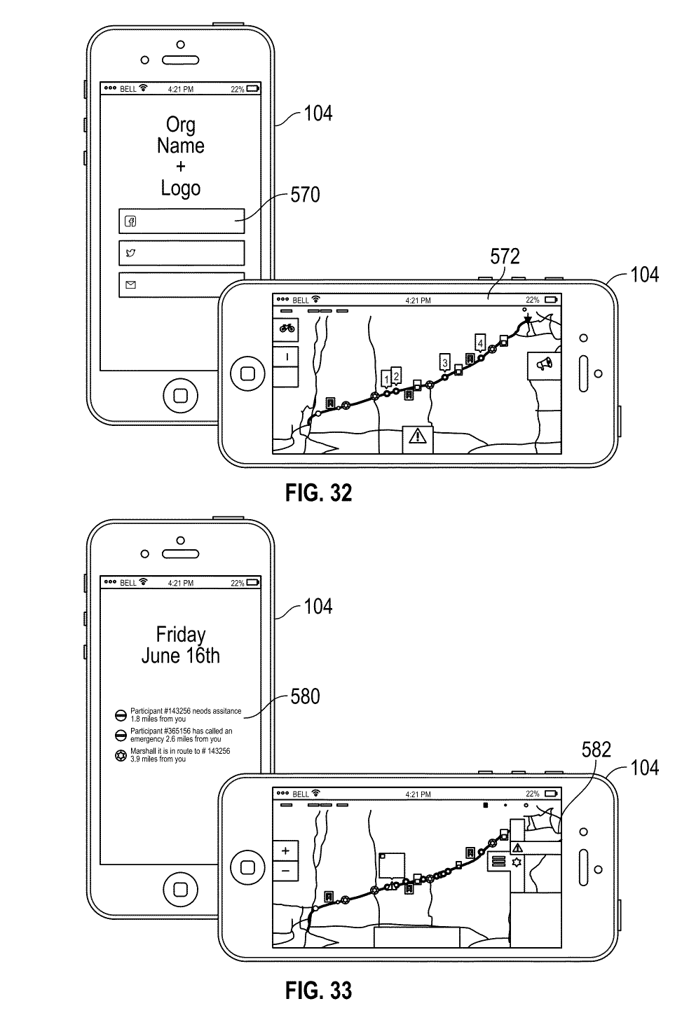

Referring now to FIGS. 32-35, shown therein is an event application executed by one of the computing devices 104 to manage a bicycle riding event according to an embodiment of the inventive concepts disclosed herein. The riding event application may be implemented similarly to the event application described above, and may provide user with a login screen 570 as shown in FIG. 32. The login screen 570 may allow users to log in with the event application or an integrated third party social network or email, or may otherwise authenticate users. In some embodiments, the event application may provide users with a rider view 572 in response to the user being authenticated. The rider view 572 may be an interactive map including one or more layers of information such as team view, water stops, terrain information, route map, help and emergency contact information, current positions of other team members, or any other desired information, or combinations thereof.

Referring now to FIG. 33, shown therein is an exemplary interface that may be provided to an event organizer (e.g., referred to as a marshal in this case). Information provided to event organizers may include an event dashboard 580 indicative or day and time or the event, riders needing assistance and distance of such riders from the organizer's location, emergency calls or signals placed by riders, and location and emergency response status of other event organizers or emergency services. The event organizer functionality may include push notifications provided to the event organizer and may also include a map overview 582 of the course or route of the event, along with locations of event participants or other event organizers, and a live feed of activity or other events happening during the event. The event activity may be provided to event organizers as a layered map, and may be provided in real-time, substantially real-time, or in near-real time to the computing device 104 by the host system 102 via the network 106, for example.

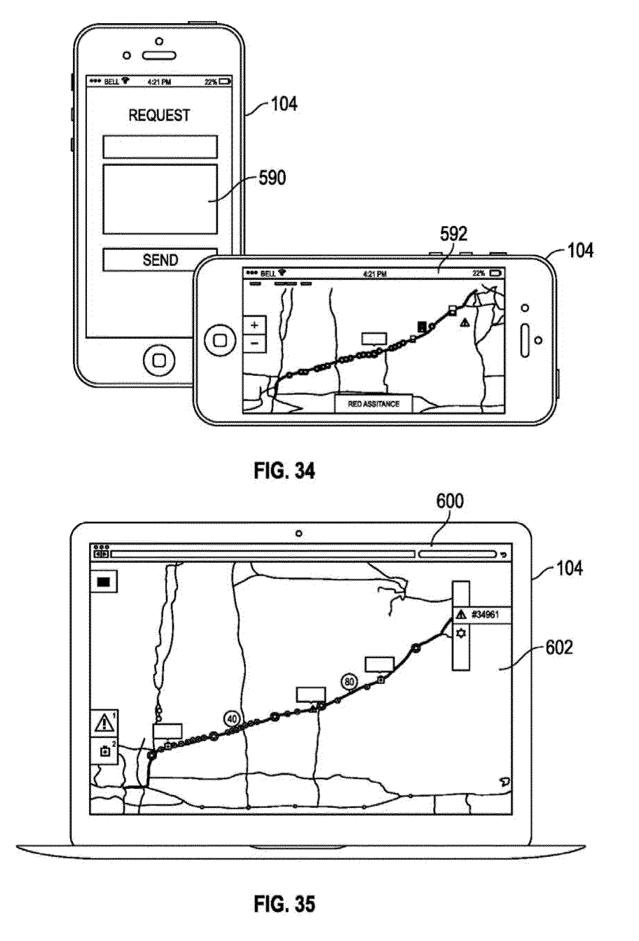

Referring now to FIG. 34 shown therein is a volunteer view functionality of an event application according to some embodiments of the inventive concepts disclosed herein. The volunteer view functionality may provide a volunteer view 590 may present users of computing devices 104 designated as volunteers with requests from users or organizers, or may allow users, organizers, or other volunteers to send requests to the user, such as supply requests, emergency requests, assistance requests, or combinations thereof. The volunteer view 590 may provide the volunteer with a live event feed 592 as described above, which live event feed 592 may include a race or ride map or route to keep volunteers informed about other riders or users of the event application in their area (e.g., any desired proximity area or distance from the location of the volunteer). Volunteers may deliver supplies or provide assistance to various areas along the event route as desired or requested.

Referring now to FIG. 35, shown therein is an administrator dashboard 600 which may be provided to administrator-level users by the host system 102 or by a computing device 104 accessing a website maintained by the host system 102 over the network 106. The administrator dashboard 600 may include an interactive map 602 showing an event overview (e.g., a race or ride overview), a live feed of various notifications exchanged between the computing devices 104 executing the event application and the host system 102 and/or between two or more computing devices 104 executing event applications, and may include sortable view of map elements or data layers, including event participants or teams locations on the event course or route, marshal or event coordinator locations, event organized vehicle locations, event photos or videos, emergency signals or requests and help messages sent to event coordinators by participants or volunteers.

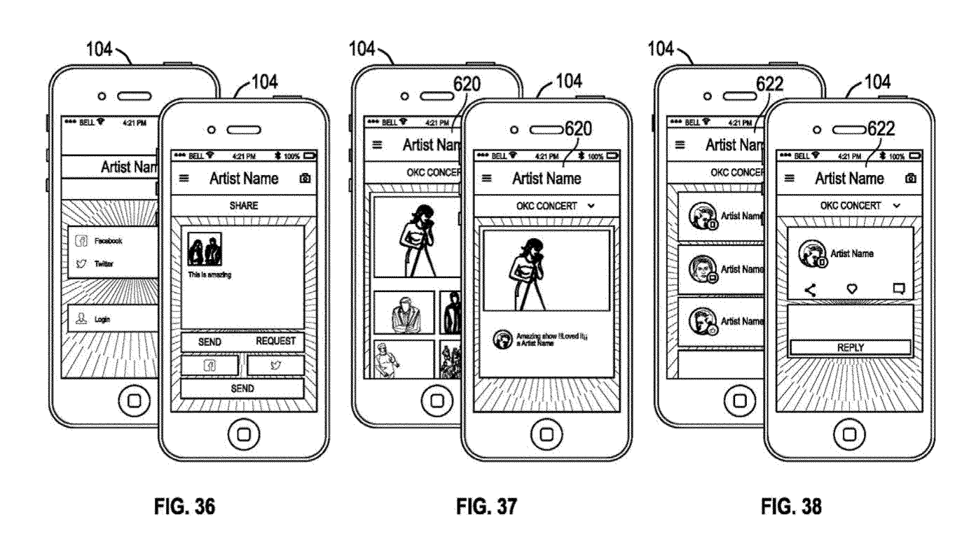

Referring now to FIGS. 36-49, shown therein is an event application for managing an artistic event according to embodiments of the inventive concepts disclosed herein.

As shown in FIG. 36, the event application may be executed on the computing device 104 and may allow users such as fans of the artist to connect with the artist and with one another via the event application and/or via integrated third party social networks. While the artist has been described as a musician, any desired artist, celebrity, public persona, religious speaker, political candidate, athlete, speaker, writer, film director, or combinations thereof may use event applications according to the inventive concepts disclosed herein.

For example, users such as fans or supporters may log in or be authenticated as described herein. In response to a user being authenticated, the event application may provide users with functionality allowing users to share social network items such as requests, messages, pictures, or videos, with other users or the event application, or to send any desired request to other users of the event applications or to social network friends, followers, or connections.

Referring now to FIG. 37, shown therein is an example of sharing interfaces 620 allowing fans to share event photos or videos, such as concert photos, videos, or status updates, which may be shared with other users of event applications according to the inventive concepts disclosed herein, or via any desired social network or third party website or service. Users may add status updates, messages, hashtags or keywords, or any other identifiers to an update, which identifiers may be picked up and tracked or added to a polling list by the host system 102 as described above.

Referring now to FIG. 38, users may be provided with a fan or user activity feed interface 622, displaying updates, photos, videos, or other items shared by other users, and may allow users to interact with one another via the event application and/or via any desired third party service or social network.

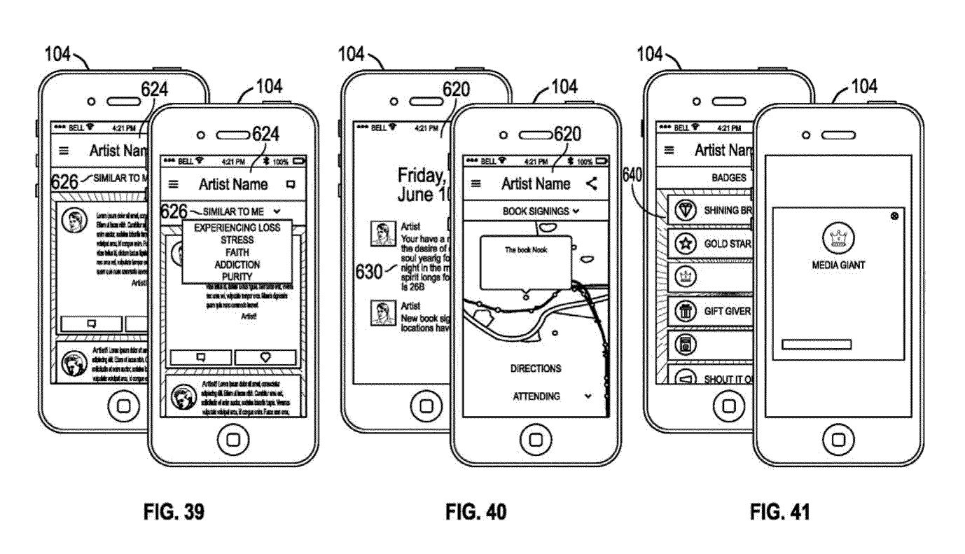

Referring now to FIG. 39, shown therein is an example of a communication interface 624 allowing users such as fans to share experiences with other fans via the event application and/or via third party services or social networks. Users may post any desired updates, and may search for users with similar experiences, problems, or updates to connect with. For example, the event application may provide users with search functionality 626 allowing users to filter or search for other users experiencing similar issues including loss, stress, faith issues, addiction, or purity issues, where the users are fans of a religious or spiritual musician. Users may also share with other users how their experience with the particular artist has influenced them or their lives, such as via a status update, photo, video, message, or combinations thereof.

Referring now to FIG. 40, in some embodiments, the artist or other event organizer may be able to push notifications and event information 630 to users of event applications, such as by providing any desired event information to the host system 102, which may then transmit some or all of the information to one or more computing devices 104 executing event applications according to the inventive concepts disclosed herein. The event information may describe the event, include quotes, messages, or updates from an artist, and may include directions to venues and locations of the event. Further, in some embodiments, event applications may provide users with user-selectable interfaces to enable users to indicate they plan to attend the event, to reserve a seat, buy a ticket, invite their friends, or combinations thereof.

Referring now to FIG. 41, shown therein is an example of gamification features 640 that may be implemented with embodiments of event applications according to the inventive concepts disclosed herein. The event application may provide users with badges, special avatars, icons, or other features for reaching one or more predetermined goals. For example, users may earn badges or other awards for attending a preset number of events, uploading a preset number of images or videos from an event, sharing a preset number of updates, events, or other items for an event, or combinations thereof. Further, users may be provided with any desired gamification-type award, badge, or indicator, for any desired fan activity tracked through the event application and/or captured from social networks or third party systems by the host system 102 as described above, or combinations thereof. The users may be provided with push notifications of gamification awards via the event application, or may be notified via email, text messaging, social network tags, or messages.

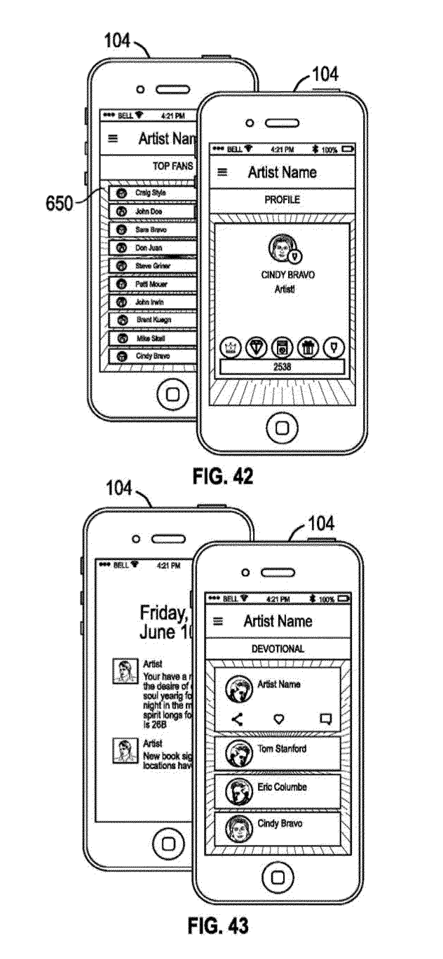

Referring now to FIG. 42, shown therein is an embodiment of award functionality 650 to provide users with awards based on the user's activity in one or more events. For example, users may be provided with badges, points, tokens, discounts, tickets, merchandise, or any other desired reward by an administrator of the event application. In some embodiments, administrators and/or users of event applications according to the inventive concepts disclosed herein may be provided with a list or ranking of top fans, or any other ranked list of users of event applications, or combinations thereof.

Referring now to FIG. 43, in some embodiments event applications according to the inventive concepts disclosed herein may be provided with push messaging or push notification functionality to allow an administrator or an artist to push one or more updates, messages, photos, videos, or any other desired items to users of the event applications. For example, messages may include upcoming events, encouraging messages, devotional messages, or any other desired communications. Further, in some embodiments the event application may provide users with functionality to allow users to push or otherwise exchange messages with one another and/or with an artist or an administrator of the event application.

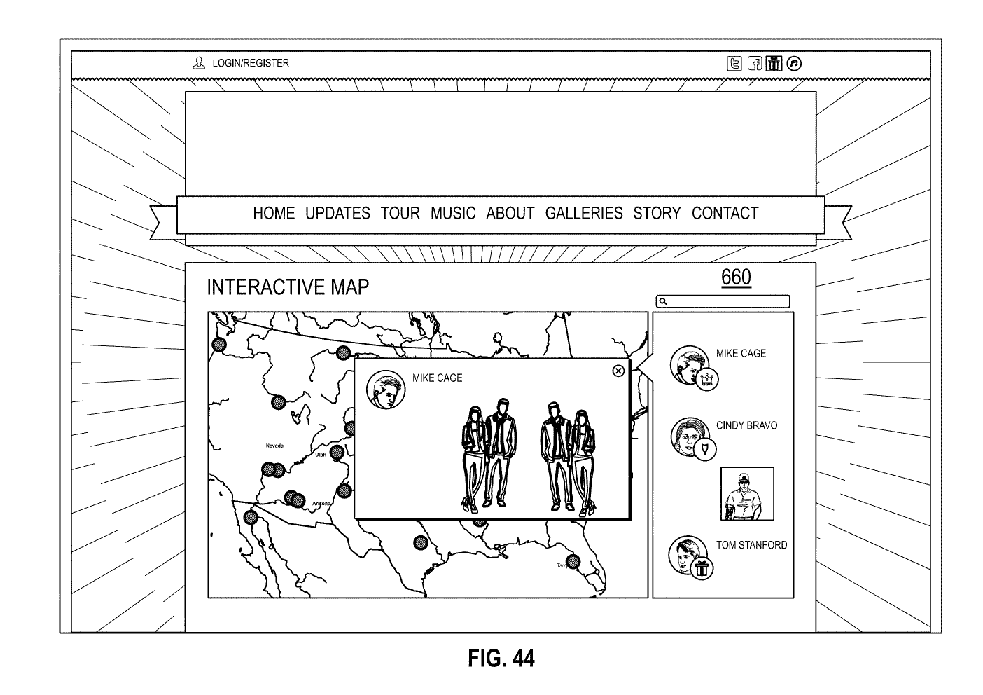

Referring now to FIG. 44, shown therein is an interactive map 660 that may be provided to administrators of the event application by the computing device 104 and/or by the host system 102. The interactive map 660 may be implemented similarly to the interactive maps described above.

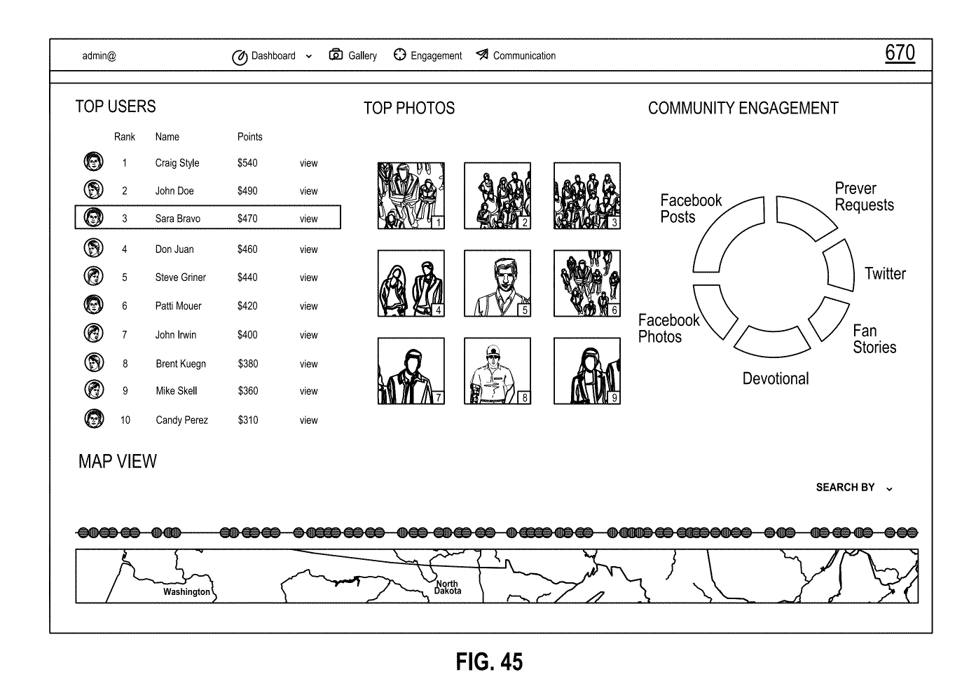

Referring now to FIG. 45, shown therein is an exemplary embodiment of a fan evaluation dashboard 670 that may be provided to an administrator by the event application and/or by the host system 102 in some embodiments.

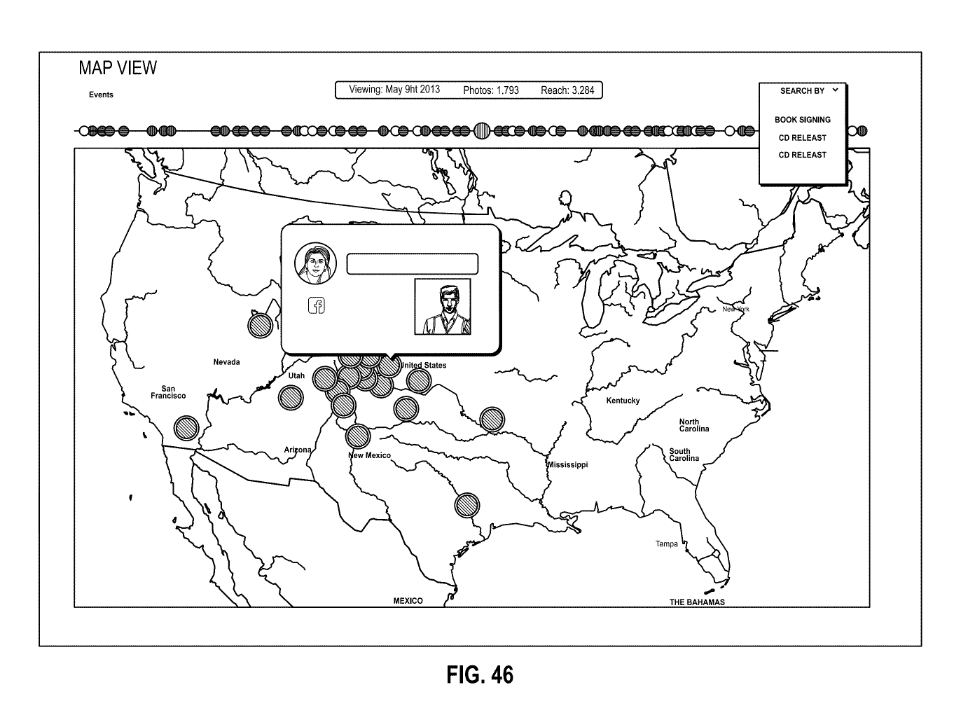

Referring now to FIG. 46, shown therein is an embodiment of an interactive map 680 which may be provided to an administrator or an artist in some embodiments of the inventive concepts disclosed herein. The interactive map 680 may function as described above, and may allow the administrator to filter fans, event, or other activity by any desired factor such as event type—e.g., a book signing, a compact disk, boom, or album release, or concert date or location, or combinations thereof, for example.

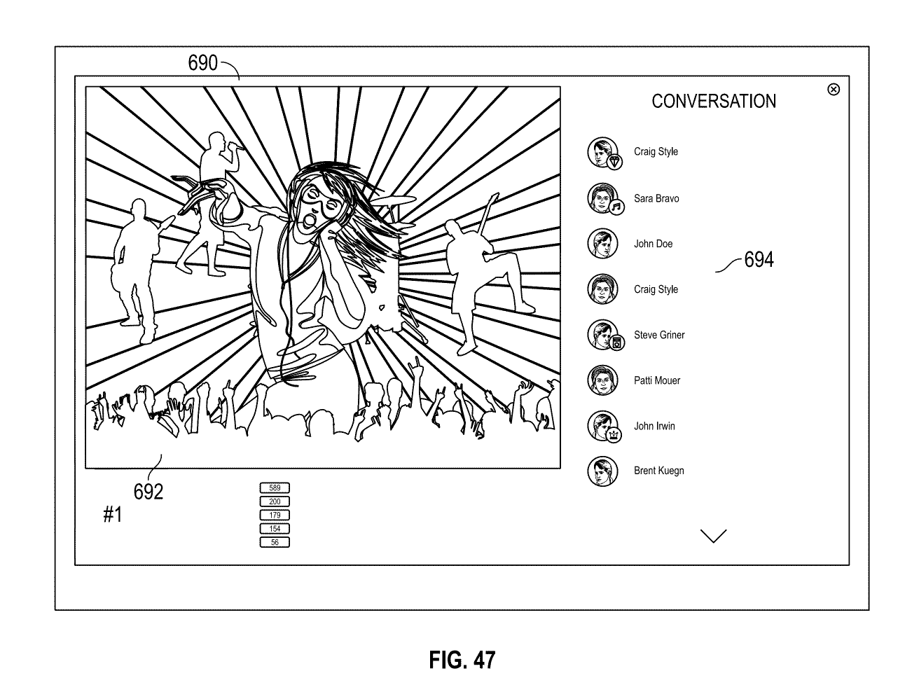

Referring now to FIG. 47, shown therein is an example of a dashboard 690 providing a live feed 692 of an event, including photos, videos, or other images of the event, along with a live feed 694 of updates posted by users of the event application via one or more computing devices 104.

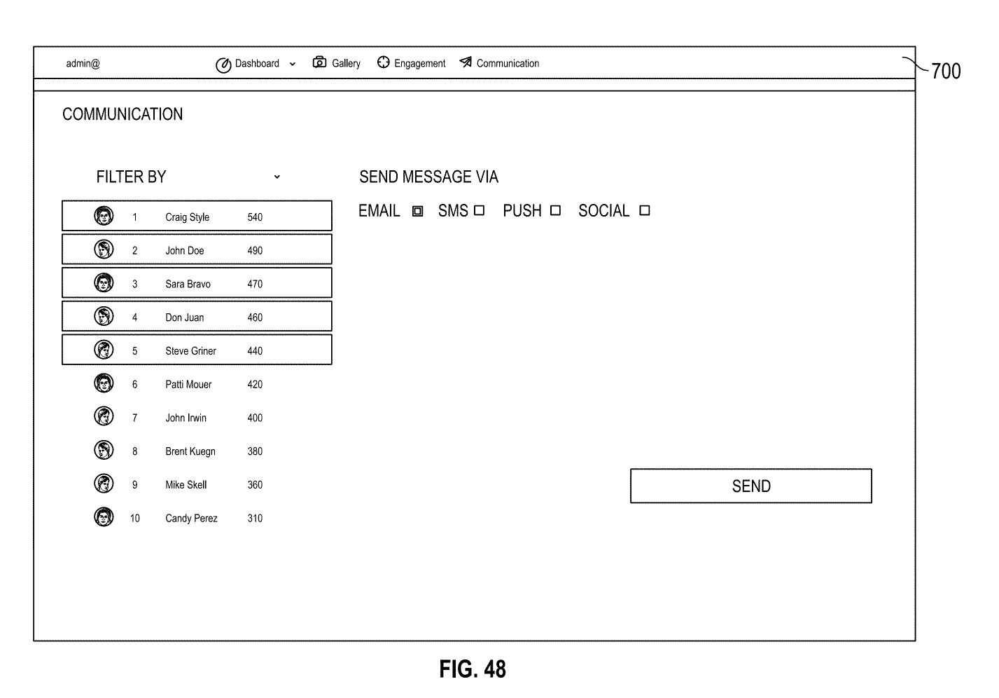

Referring now to FIG. 48, shown therein is a fan communication dashboard 700 that may be provided to an administrator by an event application according to the inventive concepts disclosed herein. The fan communication dashboard 700 may be implemented and function as described above, and may allow users to push or otherwise send messages to users of event applications according to the inventive concepts disclosed herein.

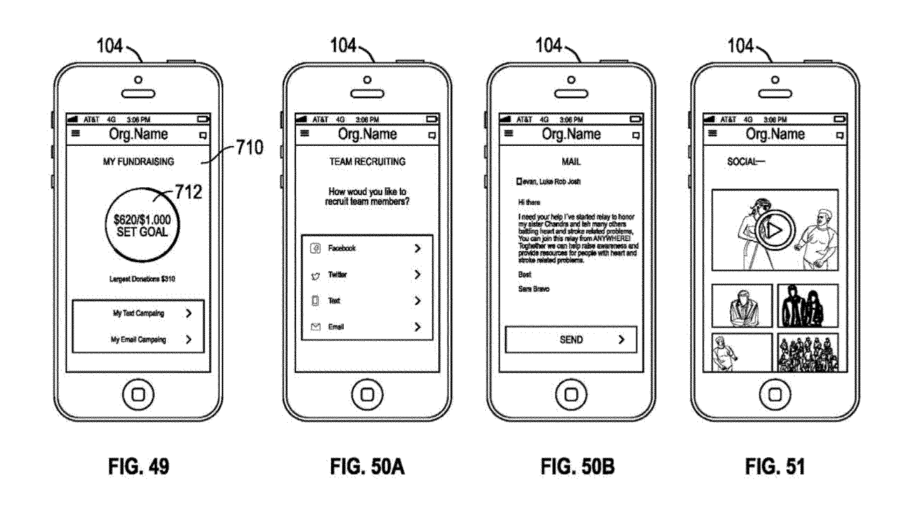

Referring now to FIGS. 49-52, shown there is an embodiment of do-it-yourself fundraising campaign functionality provided by an event application according to some embodiments of the inventive concepts disclosed herein.

As shown in FIG. 49, a user of the computing device 104 may be provided with a user interface 710 indicative of a donation campaign created by the user, along with an indicator 712 of a campaign goal and/or progress towards the goal. The user may set or change a goal and may contact other users with campaign information or requests in any desired fashion, such as by text or email, via social network or other third party messaging, or via native messaging in the event application, or combinations thereof.

As shown in FIG. 50A-50B, users may be provided with a variety of functionality by the event application, such as recruiting team members or communicating with other users or team members. Users may communicate with one another via social network or other third party messaging, emails, texts, phone calls, or push notifications or messaging within the event application, or combinations thereof.

As shown in FIG. 51, the event application may allow event participants and/or organization representatives or administrator-level users to capture event activity through event participants and supporters using computing devices 104 executing event applications according to the inventive concepts disclosed herein, such as by seeing a live activity feed indicative of event activities, photos, videos, updates, or other event-related news, shared items, activities, or updates, or combinations thereof.

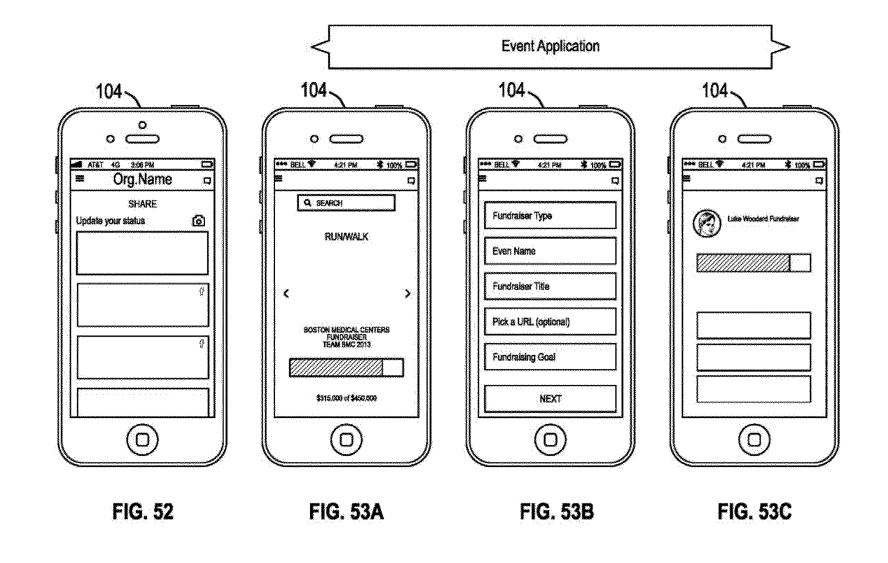

As shown in FIG. 52, in some embodiments event applications according to the inventive concepts disclosed herein may provide users with a global feed for users, event participants, supporters, or other users to see event activity, get involved in an event by participating or supporting a participant, and engage with other users and/or with organization representatives, or combinations thereof.

Referring now to FIGS. 53-57, shown therein are examples of event application functionality provided to users of the user engagement evaluation system 100 and/or the computing devices 104 in some embodiments of the inventive concepts disclosed herein.

As shown in FIG. 53A-53C, an event application according to the inventive concepts disclosed herein may allow users to search for events, view events, view event goals or goal progress, create events by providing information indicative of event type, name, title, URL address, and fundraising goal, and manage events or event teams and view various event-related reports (e.g., via a dashboard).

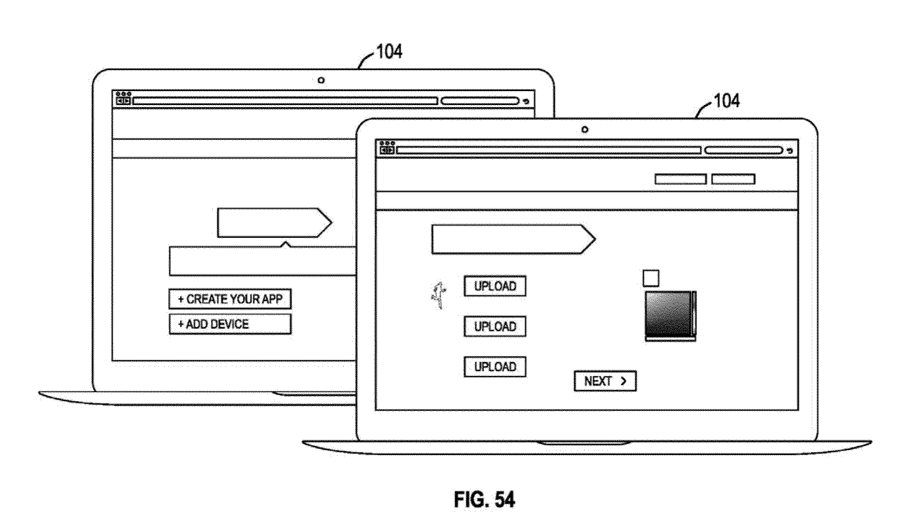

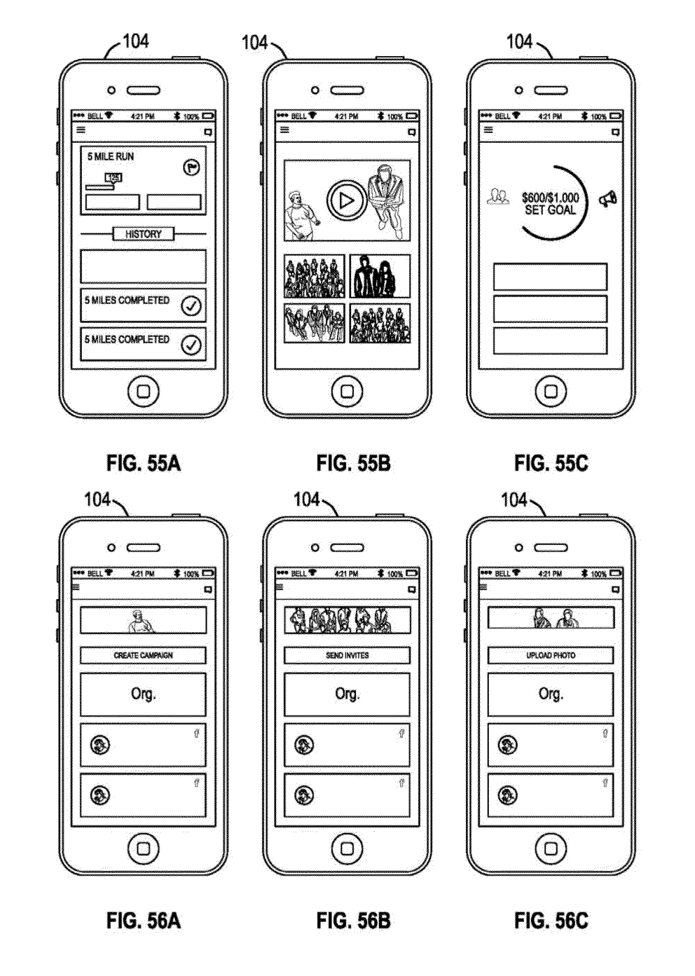

Referring now to FIGS. 54-55C, in some embodiments, event application creation may be automated by the host system 102 as described above. The event application may be provided as a “white label” application to various organizations and may allow each organization to customize the application's functionality, look and feel, appearance, or combinations thereof as described previously herein.

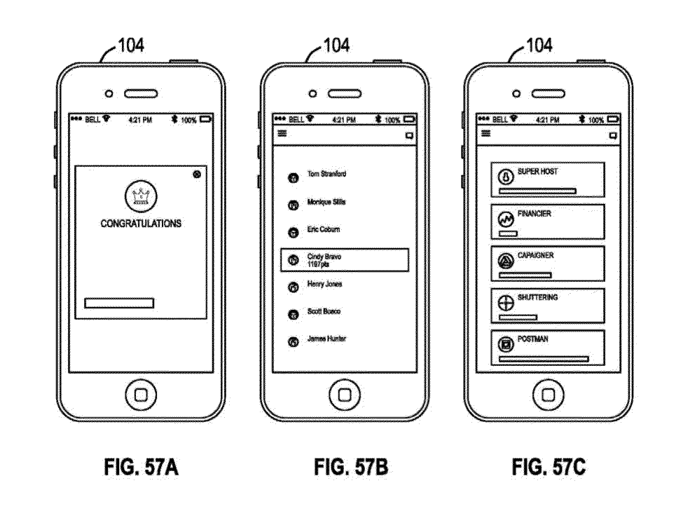

Referring now to FIGS. 56A-57C, in some embodiments event applications according to the inventive concepts disclosed herein may provide users with contest and/or reward functionality to allow organizations to drive and increase engagement and loyalty among users. For example, the event application may allow users to encourage other users, provide users with reward points, badges, rewards, items, tokens, or combinations thereof. Users may be notified of rewards earned by push notification in the event application, or in any other desired manner.

It is to be understood that while the inventive concepts disclosed herein have been described in detail in connection with charitable organizations and events, embodiments of the inventive concepts disclosed herein may be implemented with any person, organization, group, or event desiring or gauge and measure user engagement or participation. Examples of groups or organization which may use applications and systems as described herein include private clubs, private organizations, civics organizations, political organizations, non-profit, religious organizations, governmental organizations, educational institutions, commercial organizations, business entities, marketing organizations, crowdfunding, or any other desired group, individual, entity, or organization. Events where smartphone applications and computer systems according to the inventive concepts disclosed herein include charitable events, sporting events, concerts, political rallies or gatherings, religious services, camps, or events, political fundraising events, marketing campaigns, religious mission trips, disaster relief efforts, movie premieres, museum visits, art auctions or sales, trade or industry shows, training seminars, or any other desired event where one or more participants and/or one or more supporters may participate in any desired manner such as via taking part in an activity, contributing funds, joining projects or teams, or combinations thereof.

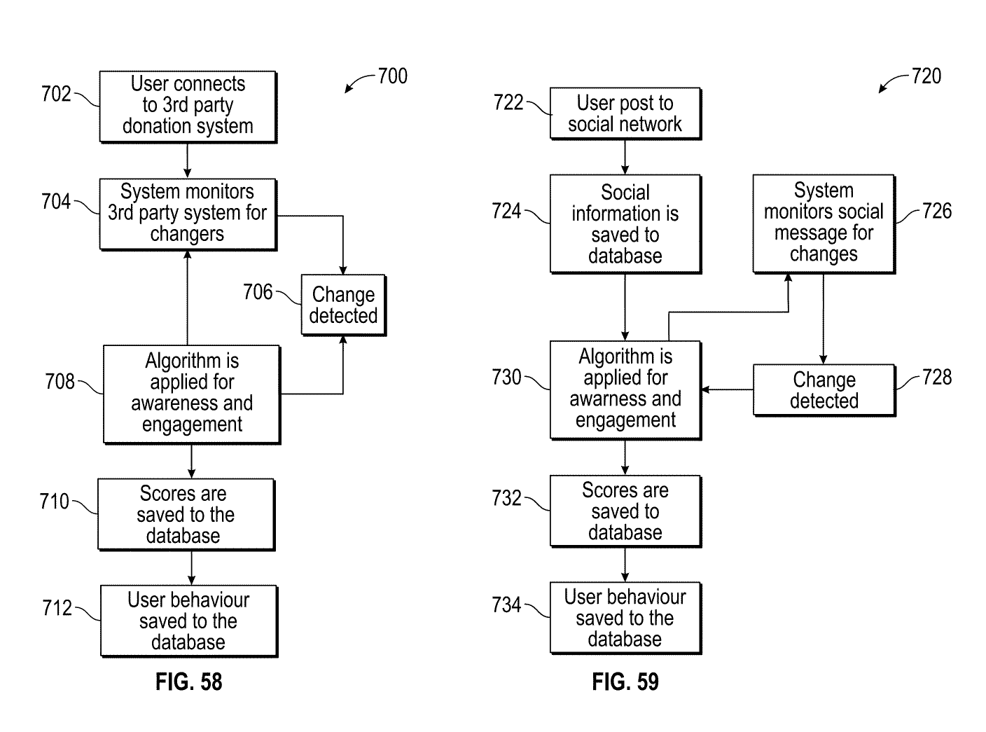

Referring now to FIG. 58, shown therein is an embodiment of third-party system integration logic 700 that may be carried out by a user engagement evaluation system 100 according to the inventive concepts disclosed herein. The user may connect to or be otherwise authenticated by a third party donation system as indicated by block 702. The third party donation system can be a donation platform via the user engagement evaluation system 100, for example. The user engagement evaluation system 100 may monitor the third party system for changes as indicated by block 704 to determine when a change is made as indicated by block 706. In response to a change being detected in the third party system, the user engagement evaluation system 100 may apply a predetermined evaluation algorithm to evaluate awareness and engagement for each changed item as indicated by a block 708. The change item may be scored by the user engagement evaluation system 100 via a predetermined algorithm, and respective users' scores may be calculated, updated, and/or stored in the user database 128, for example as indicated by blocks 710 and 712. Further, the user's behaviour (e.g., sharing, commenting, donating, etc.) may likewise be stored in the user database 128.

Referring now to FIG. 59, shown therein is an embodiment of a social network posting logic flow 720 of a user engagement evaluation system 100 according to the inventive concepts disclosed herein. A user may post or share an item (e.g., a status update, photo, and/or video) on a social network as indicated by block 722 where the user has an account, such as via an event application as described above. The user engagement evaluation system 100 stores social network information of the user in the user database 128 as indicated by block 724. The user engagement evaluation system 100 may then monitor the respective social network for changes in the social network message or items shared by the user as indicated by a block 726. As indicated by a block 728, in response to a change being detected, the user engagement evaluation system 100 may apply any desired algorithm and may calculate or recalculate the user's engagement and/or awareness score as indicated by blocks 730 and 732. The calculated or updated scores may be stored in the user database 128, along with other desired user behaviour information as indicated by block 734.

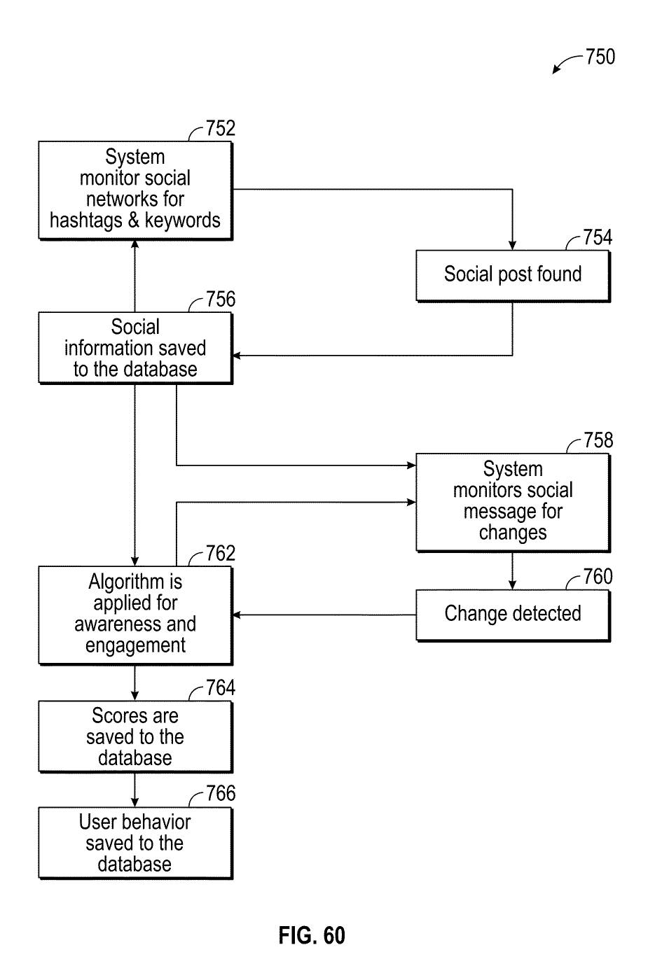

Referring now to FIG. 60, shown therein is an external social network polling logic 750 that may be executed by user engagement evaluation system 100 in some embodiments of the inventive concepts disclosed herein. The user engagement evaluation system 100 may monitor social networks for hashtags, keywords, terms, activity, events, or other items relating to a user and/or to an event managed by an event application according to the inventive concepts disclosed herein as indicated by block 752. In response to a social network post being detected or found by the user engagement evaluation system 100 (as indicated by block 754), the user engagement evaluation system 100 may pull or otherwise obtain pertinent social network information and store the information to the user database 128 and/or the event database 126 as indicated by block 756. The user engagement evaluation system 100 may monitor the social network for changes, and in response to detecting a change may update or calculate an awareness score and/or engagement score for a respective users (e.g. as described above) and may store the updated or calculated scores in the user database 128, along with any desired user behaviour data as indicated by blocks 758, 760, 762, 764 and 766.

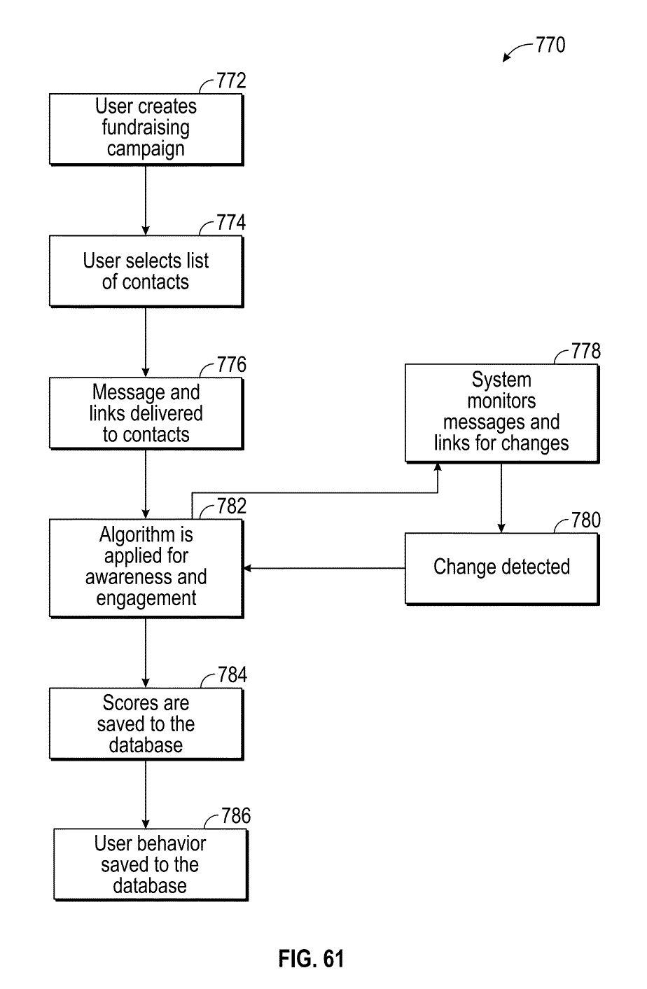

Referring now to FIG. 61, shown therein is an embodiment of do-it-yourself user campaign logic for a user engagement evaluation system 100 according to the inventive concepts disclosed herein. A user may create any desired fundraising campaign (as indicated by block 772) and may select one or more of the user's contacts to send messages and donation links to (as indicated by block 774). The user engagement evaluation system 100 sends the messages and donation links as indicated by block 776, and then monitors the messages and donation links sent out by the user for changes as indicated by block 778. In response to a change (e.g., user interaction) being detected, the user engagement evaluation system 100 may update or calculate an awareness score and/or engagement score for a respective users (e.g. as described above) and may store the updated or calculated scores in the user database 128, along with any desired user behaviour data as indicated by blocks 780, 782, 784 and 786.

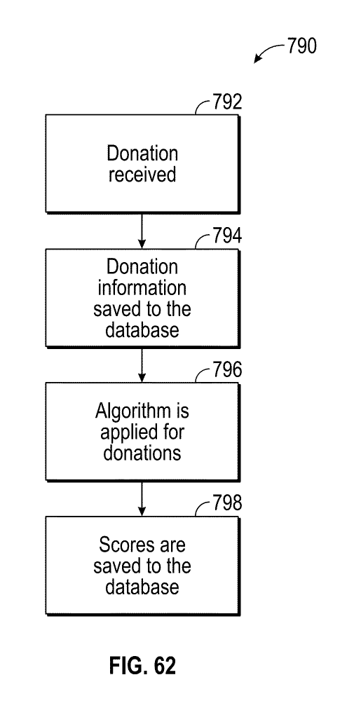

Referring now to FIG. 62, shown therein is an embodiment of donation score calculation logic 790 for a user engagement evaluation system 100 according to the inventive concepts disclosed herein. In response to a donation being received by the user engagement evaluation system 100 and/or a third party donation platform or system as a result or a message or donation link sent out by the user (as indicated by block 792), the user engagement evaluation system 100 may obtain the donation information (e.g., donor, amount, item that drove the donation, or any other desired information) and may store the donation information in the user database 128 as indicated by block 794. The user engagement evaluation system 100 may then apply any desired algorithm to calculate or update the user's donation score as indicated by block 796, and may store the calculated and/or updated user donation score in the database 128 as indicated by block 798.

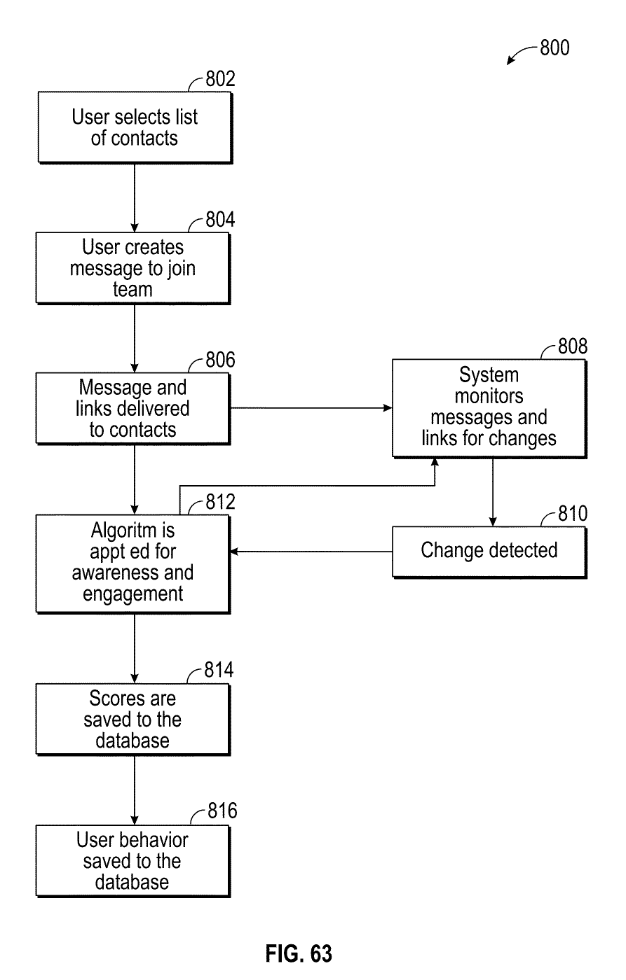

Referring now to FIG. 63, shown herein is an embodiment of user team logic 800 for a user engagement evaluation system 100 according to the inventive concepts disclosed herein. As indicated by blocks 802, 804 and 806, a user may select a list of the user's contacts, or one or more other users, and creates and sends a message inviting or requesting one or more of the selected users to join the user's team. The user engagement evaluation system 100 delivers the messages to the respective users (e.g., via push notification in event applications as described above). The user engagement evaluation system 100 may monitor the messages and links for changes as indicated by block 808. In response to detecting a change, the user engagement evaluation system 100 may apply any desired evaluation algorithm (e.g., as described above) to calculate or update the user's awareness and/or engagement score and may store the calculated or updated scores in the user database 128, along with any other desired user behaviour information as indicated by blocks 810, 812, 814, and 816.

It is to be understood that the steps disclosed herein may be performed simultaneously or in any desired order, and may be carried out by a human, or by a machine, and combinations thereof, for example. For example, one or more of the steps disclosed herein may be omitted, one or more steps may be further divided in one or more sub-steps, and two or more steps or sub-steps may be combined in a single step, for example. Further, in some exemplary embodiments, one or more steps may be repeated one or more times, whether such repetition is carried out sequentially or interspersed by other steps or sub-steps. Additionally, one or more other steps or sub-steps may be carried out before, after, or between the steps disclosed herein, for example.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. A set of instructions stored on a non-transitory computer readable medium, that when executed by one or more processors cause the one or more processors to:
gather and aggregate data streams describing a fund raising activity of a set of one or more participants in the fund raising activity, the data streams being indicative of at least two aspects of the fund raising activity from a group of activities including donations originated by the set of one or more participant, engagement of the set of one or more participant, and awareness of the set of one or more participant;
analyze the data streams with one or more rule set so as to generate a metric-based hierarchy of participants based on a composite of the set of one or more participant's relative contributions of the at least two aspects of the fund raising activity from the group of activities including donations originated by the set of one or more participant, engagement of the set of one or more participant, and awareness of the set of one or more participant;
store the metric-based hierarchy of participants; and
generate and transmit data signals indicative of at least a portion of the metric-based hierarchy to at least one computing device in a format configured to be rendered upon a display screen by the computing device using at least one predefined algorithm.

2. The set of instructions stored on the non-transitory computer readable medium of claim 1 comprising instructions to determine donations originated by the set of one or more participant as at least one of an amount raised, and an amount raised normalized by a donation goal.

3. The set of instructions stored on the non-transitory computer readable medium of claim 1 comprising instructions to cause the one or more processor to determine engagement of the set of one or more participant based on the types of user interactions by the one or more participant on different social networks along with the interactions of the one or more participant's supporters and followers.

4. The set of instructions stored on the non-transitory computer readable medium of claim 1 comprising instructions to cause the one or more processor to determine awareness of the set of one or more participant using the participant's reach across at least one communication methodology.

5. The set of instructions stored on the non-transitory computer readable medium of claim 4, wherein the at least one communication methodology uses an application running on multiple computing devices that are configured to communicate with one another and store the communications on a host system.

6. The set of instructions stored on the non-transitory computer readable medium of claim 4, wherein the at least one communication methodology includes multiple social networks where the participant has posted content.

7. The set of instructions stored on the non-transitory computer readable medium of claim 4, wherein the instructions cause the one or more processor to determine the participant's reach across social networks by determining multiple types of contacts and interactions on social networks and with each type or contact and interaction being weighted differently based on potential impact.

8. The set of instructions stored on the non-transitory computer readable medium of claim 1, wherein the participant is at least one of a supporter of the fund-raising activity, donor of the fund-raising activity, member of an organization supporting the fund-raising activity, or a team supporting the fund-raising activity.

9. A set of instructions stored on a non-transitory computer readable medium, that when executed by one or more processors cause the one or more processors of a host system to:
Monitoring, with a polling list, communication methodologies of a plurality of participants of a fund-raising activity on a user by user basis, by:
gathering data from a set of one or more data sources for a particular participant indicative of normal communication methodologies used by the participant, the normal communication methodologies selected from a group including email, text messaging, in-app messaging and social network interaction and communication;
determining a preferred communication channel for the participant based upon occurrences of types of communication methodologies within the data gathered from the one or more data sources;
generating and providing a graphical communication interface to a first computing device via a communication network with the communication dashboard identifying particular participants and the preferred communication channels for the particular participants whereby a user of the first computing device is informed of particular participants' preferred communication channels without soliciting input from the plurality of participants indicative of the participants' preferred communication channels; and
transmitting a message to a particular participant by the preferred communication channel determined by the host system for the particular participant.

10. The set of instructions stored on the non-transitory computer readable medium of claim 9, wherein transmitting the message to a particular participant is defined further as transmitting the message to multiple users simultaneously using the preferred communication channels for the particular participant.

11. The set of instructions stored on the non-transitory computer readable medium of claim 9, wherein at least one of the data sources is a communication methodology for communicating between multiple participants, and gathering includes monitoring the communication methodology with keywords and hashtags associated with particular participants.

12. The set of instructions stored on the non-transitory computer readable medium of claim 11, wherein the communication methodology uses an application running on multiple computing devices that are configured to communicate with one another and store the communications on a host system.

13. The set of instructions stored on the non-transitory computer readable medium of claim 11, wherein the communication methodology includes a social network where the participant has posted content.

14. A set of instructions stored on a non-transitory computer readable medium, that when executed by one or more processors cause the one or more processors of a host system to:
gather customer selection of criteria for a development of a multi-channel communication analytical platform pursuant to goals of an organization, the multi-channel communication analytical platform having a host system and multiple computing devices;
constructing a first portion and a second portion of the analytical platform using a set of predetermined modules including an event participant module, a fundraising module, and a multi-channel communication aggregate module, based upon the selected criteria, the first portion being an event application configured to be executed individually by multiple computing devices, and the second portion being software configured to be executed by a host system such that the first portion and the second portion of the multi-channel communication analytic platform cooperate to provide communication and predetermined functionality between the host system and the computing devices.

15. The set of instructions of claim 14, wherein the customer selection of criteria include multiple branding selections including an organizational logo and a color scheme, and wherein the first portion and the second portion are constructed to provide the branding selected by the customer.

16. The set of instructions of claim 14, wherein the multi-channel communication aggregate module is configured to:
gather data from a set of one or more data sources for a particular user indicative of normal communication methodologies used by the user, the normal communication methodologies selected from a group including email, text messaging, in-app messaging and social network interaction and communication;
determine a preferred communication channel for the user based upon occurrences of types of communication methodologies within the data gathered from the one or more data sources.

17. The set of instructions of claim 14, wherein the event application is configured to obtain a list of predetermined events offered by the organization from the host system, and to generate signals to cause the list of predetermined events to be displayed on an output device of the computing device executing the event application.

18. The set of instructions of claim 17, wherein the event application determines the location of the computing device and provides the location of the computing device to the host system to obtain the list of predetermined events offered by the organization.

19. The set of instructions of claim 17, wherein the event application is configured to permit selection of one of the predetermined events, to determine whether third party integration of at least one social network has been configured for the predetermined event and to match the event participant using the computing device to a user on the social network.

20. The set of instructions of claim 17, wherein the event application is configured to permit selection of one of the predetermined events and to present a social network login screen to the event participant on an output device of the computing device running the event application.

21. The set of instructions of claim 14, wherein the event application is configured to obtain a list of predetermined events offered by the charitable organization from the host system, to generate signals to cause the list of predetermined events to be displayed on an output device of the computing device executing the event application, to receive selection of one of the events, and to determine whether the user operating the computing device is a participant of the event, or a supporter of the event, wherein, upon determination that the user operating the computing device is a participant of the event, the event application branches to first logic, and upon determination that the user operating the computing device is a supporter of the event, the event application branches to second logic.

22. The set of instructions of claim 21, wherein the second logic includes logic for logging into a social network and accessing a predetermined event feed associated with the event selected by the user of the computing device.

23. The set of instructions of claim 14, wherein the event application is configured to obtain a list of predetermined events offered by the organization from the host system, to generate signals to cause the list of predetermined events to be displayed on an output device of the computing device executing the event application, to receive selection of one of the events, to determine a status of the event being one of a pre-event, a post event, and a during event, and to branch to predetermined logic dependent upon the status of the event.

24. The set of instructions of claim 14, wherein the organization is a charitable organization.
